(19) United States
(12) Patent Application Publication
(10) Pub. No.: US 2015/0080105 A1
(43) Pub. Date: Mar. 19, 2015

(54) GAMING MACHINE

(71) Applicants: Universal Entertainment Corporation, Tokyo (JP); Aruze Gaming America, Inc., Las Vegas, NV (US)

(72) Inventors: Takehisa ITAGAKI, Tokyo (JP); Yuji MIYAGAWA, Tokyo (JP); Hiroki NAKAMURA, Tokyo (JP); Yoichi KATO, Tokyo (JP)

(21) Appl. No.: 14/484,379

(22) Filed: Sep. 12, 2014

(30) Foreign Application Priority Data
Sep. 19, 2013 (JP) 2013-194405

(51) Int. Cl. G07F 17/32; G07F 17/34

(52) U.S. Cl. CPC G07F 17/3213; G07F 17/34
USPC 463/20

(57) ABSTRACT

Provided is a gaming machine having new entertainment features, which is achieved by adding new elements in providing a bonus. The gaming machine determines symbols to be rearranged in a display region at random, selects one kind of symbols from a plurality kinds of symbols, places the one kind of symbols in the symbol array associated with at least one of multiple scroll lines, stores symbol arrays in a memory, and scrolls the symbol arrays associated with the scroll lines based on the symbol arrays stored in the memory.

### CROSS-REFERENCE TO RELATED APPLICATIONS

This application is based on and claims a priority from the prior Japanese Patent Application No. 2013-194405 filed on Sep. 19, 2013, the entire contents of which are incorporated herein by reference.

### BACKGROUND OF THE INVENTION

1. Technical Field

The present invention relates to a gaming machine.

2. Background Art

Traditional slot machines (gaming machines) are configured to, in response to a player's actions of insertion of a coin or a bill in a slot of the slot machine and operation of a spin button, display a plurality of symbols scrolling in a symbol display area provided on the front of the housing and subsequently stop the symbols automatically. Based on the condition of the stopped symbols, whether to provide any prize such as a bonus is determined (for example, refer to US Patent Application Publication No. 2011/0250947).

There exists a kind of slot machine which offer a plurality of bonuses; based on the player's operation of an input device such as a button, it selects one of the plurality of bonuses to conduct the selected bonus (for example, refer to US Patent Application Publication No. 2009/0104973).

### SUMMARY OF INVENTION

With a slot machine (gaming machine) which offer a plurality of bonuses, a player usually plays games with much interest in the specifics of the plurality of bonuses.

An object of the present invention is to provide a gaming machine having new entertaining features, by adding new elements related to providing bonuses.

An embodiment of a gaming machine according to the present invention is a gaming machine for determining a game result in accordance with symbols rearranged out of a plurality of kinds of symbols, the gaming machine comprising:

a memory for storing symbol arrays formed of a plurality of symbols, the symbol arrays being associated with a plurality of scroll lines on a one-to-one basis;

a display having a display region in which symbols are rearranged; and

a controller for controlling a unit game in which the symbol arrays associated with the plurality of scroll lines are scrolled at a predetermined speed and then symbols are rearranged in the display region to determine a game result, the controller being programmed to perform the following processing of (1-1) to (1-4):

(1-1) determining symbols to be rearranged in the display region at random;

(1-2) selecting one kind of symbols from the plurality kinds of symbols at random;

(1-3) successively placing the one kind of symbols in at least one of the symbol arrays associated with the plurality of scroll lines and storing the symbol arrays in the memory; and

(1-4) scrolling the symbol arrays associated with the plurality of scroll lines based on the symbol arrays stored in the memory in the processing of (1-3).

According to the forgoing configuration, one kind of symbols are successively placed in at least one of the symbol arrays associated with the plurality of scroll lines. For this reason, the one kind of symbols are more likely to be rearranged in a result of a unit game. The player can feel more expectation through increased possibility of payout of a dividend for the one kind of symbols.

In the gaming machine according to an embodiment of the present invention, the processing of (1-4) includes the following processing of (2-1):

(2-1) in a case where the processing of (1-3) successively places the one kind of symbols, scrolling the at least one of the symbol arrays including the one kind of symbols at a speed different from the predetermined speed.

According to the forgoing configuration, the symbol arrays including the one kind of symbols are scrolled at a speed different from a predetermined speed. For this reason, the player can see the one kind of symbols scrolling at a speed different from a normal speed, increasing the expectation for the dividend for the one kind of symbols.

In the gaming machine according to an embodiment of the present invention, the processing of (1-2) includes the following processing of (3-1):

(3-1) selecting one kind of symbols from the plurality of kinds of symbols before starting scrolling the symbol arrays.

According to the foregoing configuration, one kind of symbols are selected before the start of scrolling. As a result, when one kind of symbols are placed, the one kind of symbols are inevitably scrolled to show the existence of the one kind of symbols to the player. The player can feel more expectation.

In the gaming machine according to an embodiment of the present invention,

the unit game is performed in both of a base game mode and a bonus game mode entered from the base game mode, and

the processing of (1-2) to (1-4) is performed in at least either the base game mode or the bonus game mode.

According to the foregoing configuration, one kind of symbols are placed in at least either the base game mode or the bonus game mode. As a result, the player can feel more expectation.

In the gaming machine according to an embodiment of the present invention, the processing of (1-3) includes the following processing of (5-1):

(5-1) successively placing the one kind of symbols along a scroll line in a direction away from symbols rearranged in the display region in a previous unit game, from a position away from the symbols by a predetermined number of symbols.

According to the foregoing configuration, the one kind of scrolled symbols can be seen by the player after start of scrolling. The player can recognize the existence of the one kind of symbols, feeling more expectation.

A gaming machine having new entertaining features can be provided by adding new elements in providing bonuses.

### BRIEF DESCRIPTION OF DRAWINGS

FIG. 1 is a general diagram illustrating an outline of the game offered by a slot machine in an embodiment;

FIG. 2 is a view illustrating a functional flow of the slot machine in the embodiment;

FIG. 3 is a view illustrating a game system including gaming machines;

FIG. 4 is a view illustrating an overall configuration of the slot machine in the embodiment;

FIG. 5 is a view illustrating a control panel of the slot machine in the embodiment;

FIG. 6 is a block diagram illustrating an internal configuration of the slot machine in the embodiment;

FIG. 7 is a view illustrating symbol arrays of video reels of the slot machine in the embodiment;

FIG. 8 is an illustrative view of an image displayed on the lower image display panel of the slot machine in the embodiment;

FIG. 9 is an illustrative view of paylines of the slot machine in the embodiment;

FIG. 10 is a table illustrating a number-of-payouts determination table of the slot machine in the embodiment;

FIG. 11 is a table illustrating a number-of-free-games determination table of the slot machine in the embodiment;

FIG. 12 is a table illustrating a roulette game dividend table of the slot machine in the embodiment;

FIG. 13 is a flowchart illustrating the main control processing for the slot machine in the embodiment;

FIG. 14 is a flowchart illustrating the coin insertion/start check processing for the slot machine in the embodiment;

FIG. 15 is a flowchart illustrating the symbol rewrite processing for the slot machine in the embodiment;

FIG. 16 is a flowchart illustrating the symbol display control processing for the slot machine in the embodiment;

FIG. 17 is a flowchart illustrating the bonus game processing for the slot machine in the embodiment;

FIG. 18 is a flowchart illustrating the free game execution processing for the slot machine in the embodiment;

FIG. 19 is a flowchart illustrating the free game addition processing for the slot machine in the embodiment;

FIG. 20 is a flowchart illustrating the roulette game execution processing for the slot machine in the embodiment;

FIG. 21A is a view illustrating a table for determining the manner to stop the scrolling;

FIG. 21B is a view illustrating a table for determining the manner to stop the scrolling;

FIG. 22A is a view illustrating symbol arrays before rewriting the symbols and the symbols rearranged in the symbol display region 4 when the first to the fifth video reels 3a to 3e are stopped;

FIG. 22B is a view illustrating symbol arrays after rewriting the symbols assuming that the rewrite start position is code No. 16, which is obtained by subtracting 2 from code No. 18;

FIG. 22C is a view illustrating symbol arrays after rewriting the symbols assuming that the rewrite start position is code No. 15, which is obtained by subtracting 3 from code No. 18;

FIG. 22D is a view illustrating symbol arrays after rewriting the symbols assuming that the rewrite start position is code No. 14, which is obtained by subtracting 4 from code No. 18;

FIG. 22E is a view illustrating symbol arrays after rewriting the symbols assuming that the rewrite start position is code No. 16, which is obtained by subtracting 16 from code No. 32;

FIG. 22F is a view illustrating symbol arrays after rewriting the symbols assuming that the rewrite start position is code No. 15, which is obtained by subtracting 17 from code No. 32;

FIG. 22G is a view illustrating symbol arrays after rewriting the symbols assuming that the rewrite start position is code No. 14, which is obtained by subtracting 18 from code No. 32;

FIG. 23 is a view illustrating a scrolling speed in the case where symbols are replaced by TEN symbols; and

FIG. 24 is a view illustrating a scrolling speed in the case where symbols are replaced by FEATURE symbols.

### DESCRIPTION OF EMBODIMENTS

### Overview

A slot machine 10 is a kind of gaming machine. The present embodiment describes a slot machine 10 by way of example of a gaming machine; however, the gaming machine is not limited to this and may be a device that can independently conduct a certain kind of base games and further, bonus games progressed from the base games.

Base games in the present embodiment are conducted in a slot machine 10. The base games are slot games that rearrange a plurality of symbols each time. The base games are games conceptually confronting free games and a roulette game as bonus games.

Rearrangement of the symbols in slot games is shown on a lower image display panel 141. The slot games include processing to conduct base games (base game mode) and processing to conduct free games (free game mode). A base game is, under the condition where some game value is bet, to rearrange symbols on the lower image display panel 141 and pay out a normal dividend in accordance with the rearranged symbols. A free game is, when symbols rearranged in a base game satisfy a predetermined condition, to rearrange symbols under conditions different from those of a base game and pay out a dividend in accordance with the rearranged symbols.

The symbol is a generic term representing JACK, QUEEN, KING, NINE, ACE, TEN, MOUSE, RABBIT, DEER, WOLF, WILD, FEATURE, or BOX symbols.

The game value represents coins, bills, or electrically valuable information corresponding to these. The game value in the present embodiment is not specifically limited and may be game media such as medals, tokens, electric money, or tickets. The tickets are not specifically limited and may be later-described tickets with barcodes.

The bonus games in the present embodiment may be any kind of games as far as they have a game style different from that of base games. In the present embodiment, free games or a roulette game (one-time game) are conducted. Free games are conducted with a smaller bet of game value than base games. A smaller bet of game value includes zero bet. Accordingly, free games may be games that do not require a bet of game value and pays game value in the amount corresponding to the rearranged symbols. In other words, free games may be games that are started without requirement of game value consumption.

In contrast, base games are games that require a bet of game value to be conducted and pays game value in the amount corresponding to the rearranged symbols. In other words, base games are games that are started with requirement of game value consumption.

The roulette game in the present embodiment is a game that conducts a lottery to determine a dividend based on winning probabilities associated with individual dividends. The roulette game as a one-time game may be any kind of game as far as it provides a special benefit through a single lottery.

### <Rearrangement>

Rearrangement means a state in which symbols have been placed again after an arrangement of symbols is released. An arrangement of symbols is released by start of a unit game (slot game) and subsequently, another set of symbols are placed again (rearranged). The rearranged symbols determine a result of the game to terminate the unit game. Arrangement means a state in which symbols are visible by the player in the outside.

### <<Overview of Slot Machine 10>>

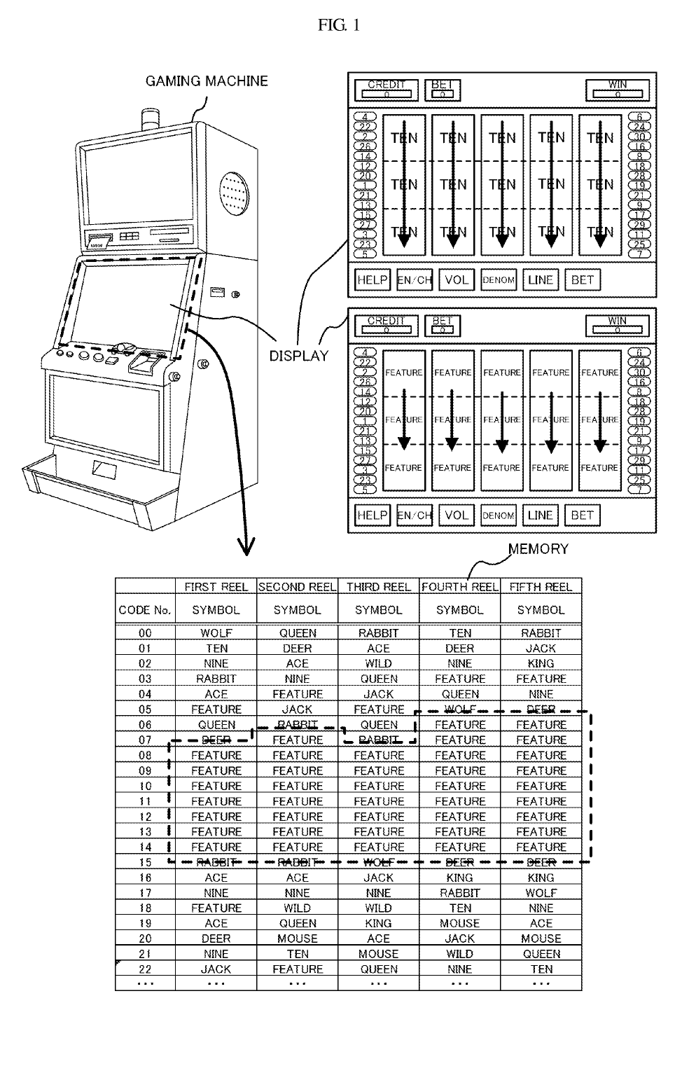

As illustrated in FIG. 1, the gaming machine according to the present embodiment is a gaming machine (e.g., later-described slot machine 10) for determining a game result in accordance with symbols rearranged out of a plurality of kinds of symbols and comprises:

a memory (e.g., later-described RAM 73) for storing symbol arrays formed of a plurality of symbols, the symbol arrays being associated with a plurality of scroll lines on a one-to-one basis;

a display (e.g., later-described lower image display panel 141) having a display region in which symbols are rearranged; and

a controller (e.g., later-described main CPU 71) for controlling a unit game in which the symbol arrays associated with the plurality of scroll lines are scrolled at a predetermined speed and then symbols are rearranged in the display region to determine a game result, the controller being programmed to perform the following processing of (1-1) to (1-4):

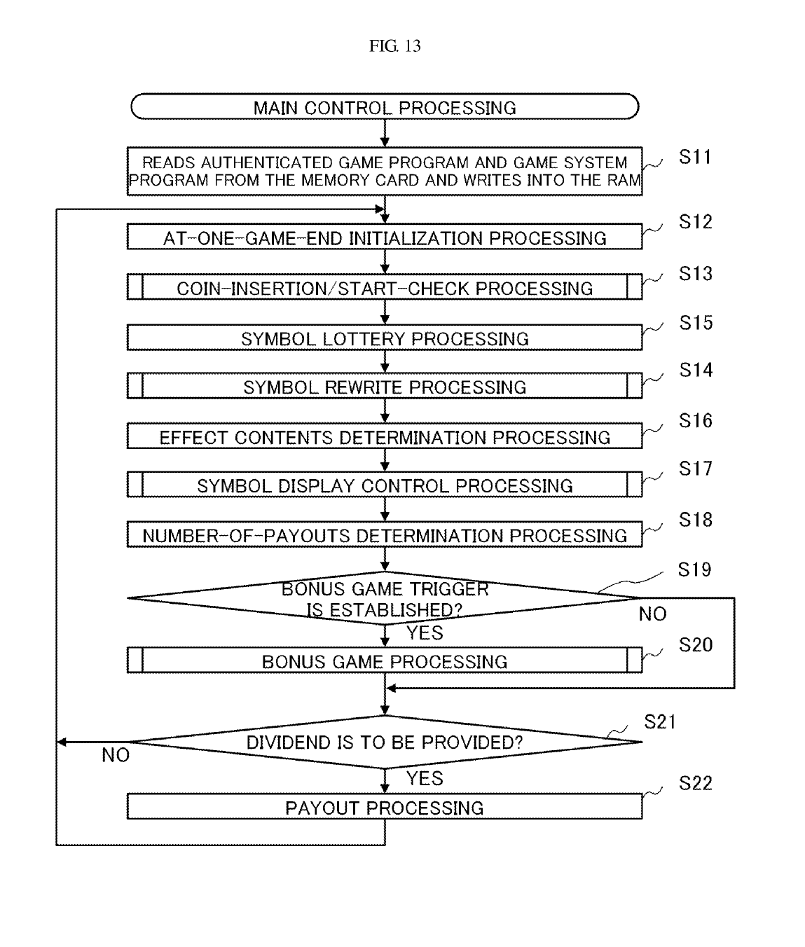

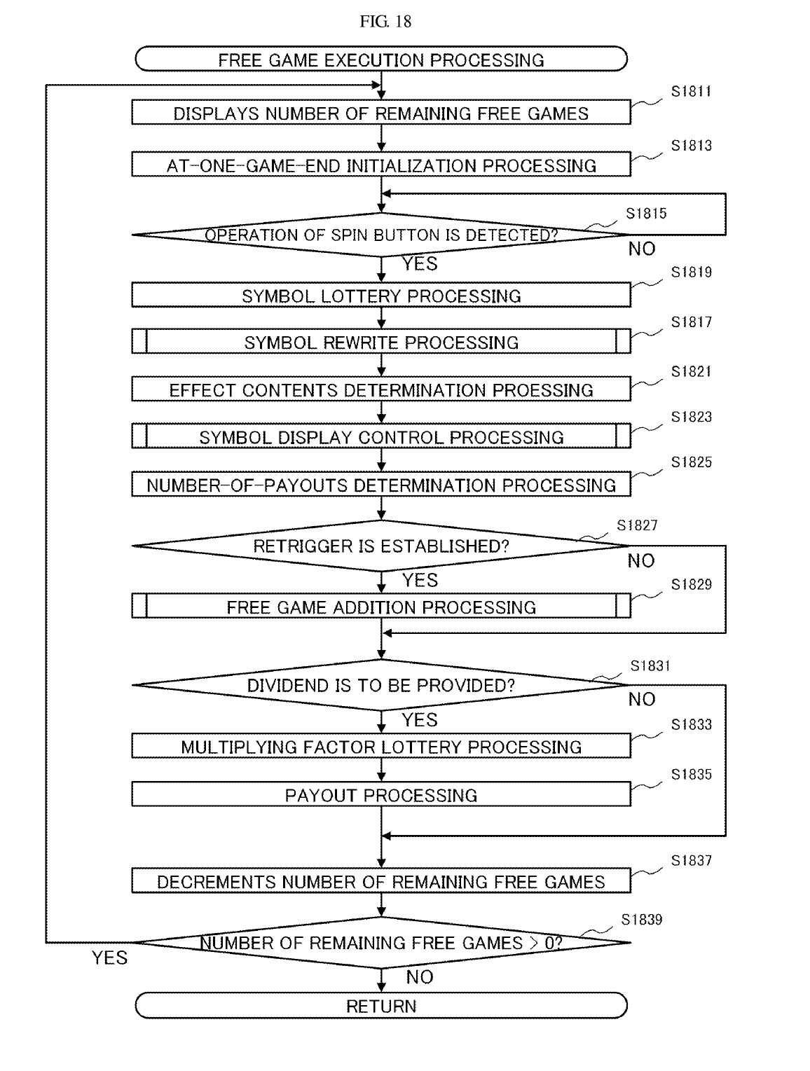

(1-1) determining symbols to be rearranged in the display region at random (e.g., later-described step S15 in FIG. 13 and step S1819 in FIG. 18);

(1-2) selecting one kind of symbols from the plurality kinds of symbols at random (e.g., later-described step S14 in FIG. 13 and step S1817 in FIG. 18);

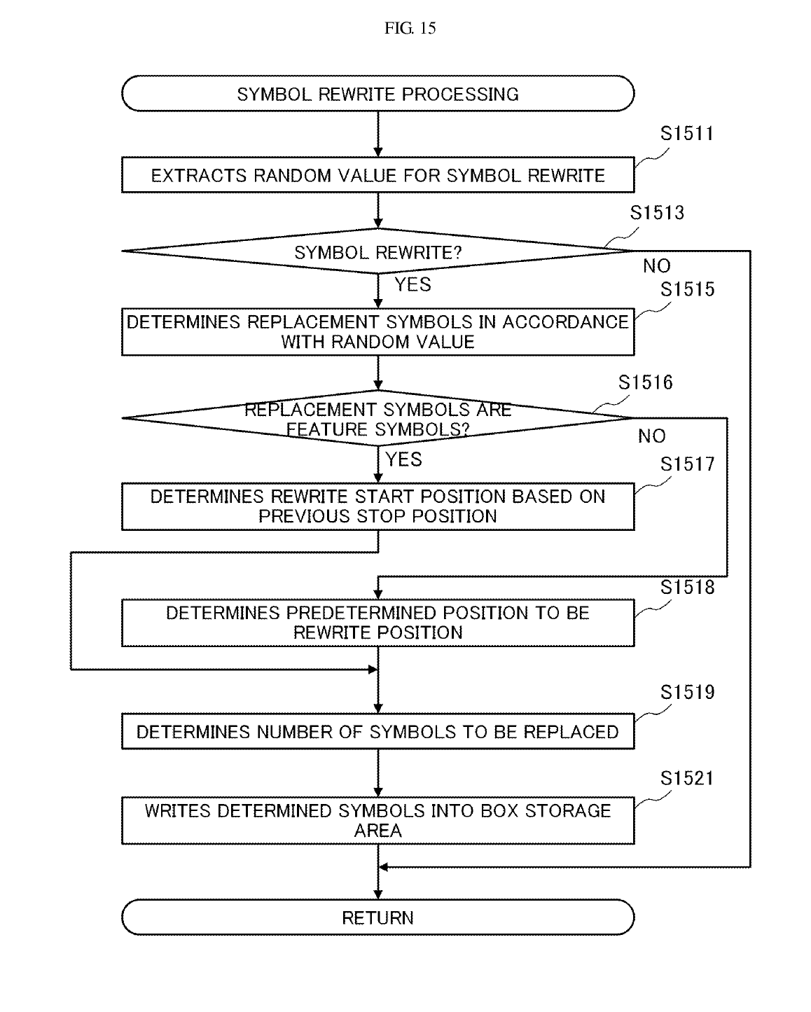

(1-3) successively placing the one kind of symbols in at least one of the symbol arrays associated with the plurality of scroll lines and storing the symbol arrays in the memory (e.g., later-described step S1521 in FIGS. 15); and

(1-4) scrolling the symbol arrays associated with the plurality of scroll lines based on the symbol arrays stored in the memory in the processing of (1-3) (e.g., later-described step S17 in FIG. 13 and step S1823 in FIG. 18).

The gaming machine in the present embodiment determines a game result in accordance with symbols rearranged out of a plurality of kinds of symbols. The game result needs to result in determination whether to provide a benefit to the player, such as paying a dividend or entering bonus games.

The gaming machine includes a memory, a display, and a controller.

The memory stores symbol arrays. Each symbol array is formed of a plurality of symbols placed in a specified sequence. The plurality of symbols in a symbol array are associated with one of a plurality of scroll lines.

The display has a display region. In the display region, symbols are rearranged.

The controller controls unit games. A unit game is a game in which the symbol arrays associated with the plurality of scroll lines are scrolled at a predetermined speed and then symbols are rearranged in the display region to determine a game result. The symbol arrays are scrolled at a predetermined speed. The controller performs the following processing of (1-1) to (1-4).

The processing of (1-1) determines symbols to be rearranged in the display region at random. The processing needs to determine the symbols to be rearranged at random, for example, by lottery. Although the lottery is conducted to draw a random number at random, the drawing probabilities may be different using weights. Such an approach can define a symbol more likely to be drawn or less likely to be drawn.

The processing of (1-2) selects one kind of symbols from the plurality kinds of symbols at random. The processing needs to select one kind of symbols at random, for example, by lottery. In this processing, too, the lottery may be conducted to draw a random number at random, however, the drawing probabilities may be different using weights. Such an approach can define a kind of symbols more likely to be drawn or less likely to be drawn.

The processing of (1-3) successively places the one kind of symbols in at least one of the symbol arrays associated with the plurality of scroll lines and stores the symbol arrays in the memory. The processing needs to be performed on at least one of the plurality of scroll lines. Accordingly, this processing may be performed on all of the scroll lines.

The processing successively places one kind of symbols in a symbol array. For example, the placing may be replacing a part of the plurality of symbols forming the target symbol array with one kind of successive symbols. Also, the placing may be inserting one kind of successive symbols in the plurality of symbols forming the target symbol array. Regardless of the way of placing the symbols, one kind of symbols need to be successively placed. Furthermore, the required is one kind of symbols are successively placed; any number of symbols can be successive. An appropriate number can be selected such that the player can recognize one kind of symbols are successively placed.

The memory needs to store, for each of the symbol arrays, a sequence of identification information to identify the plurality of symbols forming the symbol array. The plurality of symbols can be identified and displayed by retrieving the sequence of identification information.

The processing of (1-4) scrolls the symbol arrays associated with the plurality of scroll lines based on the symbol arrays stored in the memory in the processing of (1-3). As described above, sequences of identification information to identify a plurality of symbols are stored in the memory. The processing retrieves the sequences of identification information to identify and display the plurality of symbols forming the symbol arrays.

According to the forgoing configuration, one kind of symbols are successively placed in at least one of the symbol arrays associated with the plurality of scroll lines. For this reason, the one kind of symbols are more likely to be rearranged in a result of unit game. The player can feel more expectation through increased possibility of payout of a dividend for the one kind of symbols.

In a gaming machine according to the present embodiment, the processing of (1-4) includes the following processing of (2-1):

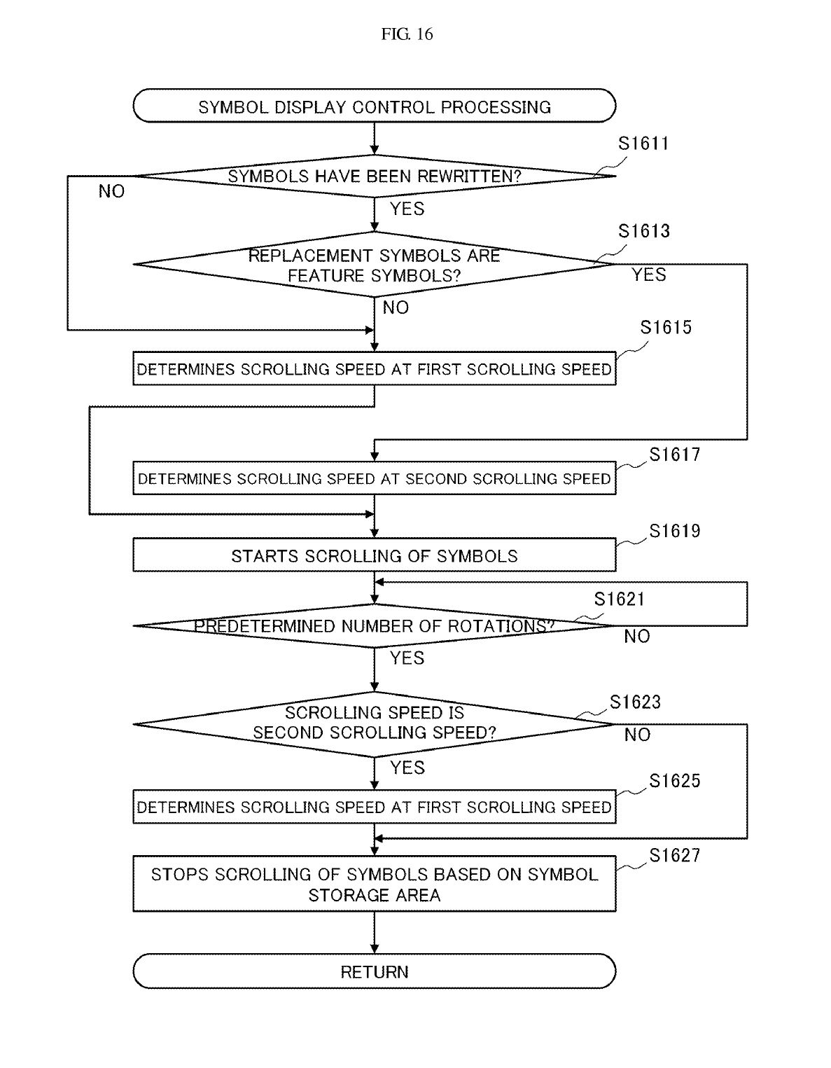

(2-1) in a case where the processing of (1-3) successively places the one kind of symbols, scrolling the at least one of the symbol arrays including the one kind of symbols at a speed (e.g., later-described second scrolling speed) different from the predetermined speed (e.g., later-described first scrolling speed) (e.g., later-described step S1617 in FIG. 16).

According to the forgoing configuration, when one kind of symbols are successively placed, the symbol arrays including the one kind of symbols are scrolled at a speed different from a predetermined speed. For this reason, the player can easily recognize by sight that one of a plurality kinds of symbols are included in the symbol array. The player recognizes the one kind of symbols scrolling at an unusual speed by sight, feeling more expectation for the dividend for the one kind of symbols.

In a gaming machine according to the present embodiment, the processing of (1-2) includes the following processing of (3-1):

(3-1) selecting one kind of symbols from the plurality of kinds of symbols before starting scrolling the symbol arrays (e.g., later-described step S15 and S17 in FIG. 13, and step S1817 and S1823 in FIG. 18).

According to the foregoing configuration, one kind of symbols are selected before the start of scrolling. As a result, when one kind of symbols are placed, they are inevitably scrolled to show the existence of the one kind of symbols to the player. The player can feel more expectation.

In a gaming machine according to the present embodiment,

the unit game is performed in both of a base game mode and a bonus game mode entered from the base game mode, and

the processing of (1-2) to (1-4) is performed in at least either the base game mode or the bonus game mode (e.g., later-described processing in FIG. 13 and processing in FIG. 18).

According to the foregoing configuration, one kind of symbols are placed in at least either the base game mode or the bonus game mode. As a result, the player can feel more expectation.

In a gaming machine according to the present embodiment, the processing of (1-3) includes the following processing of (5-1):

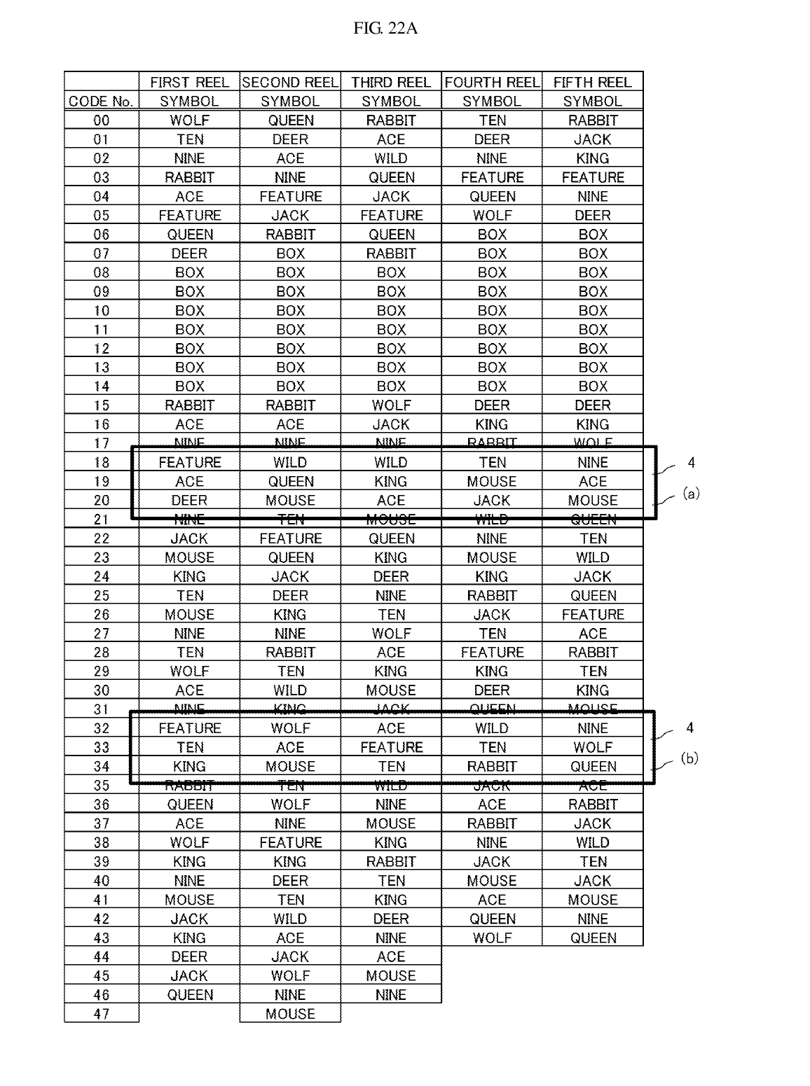

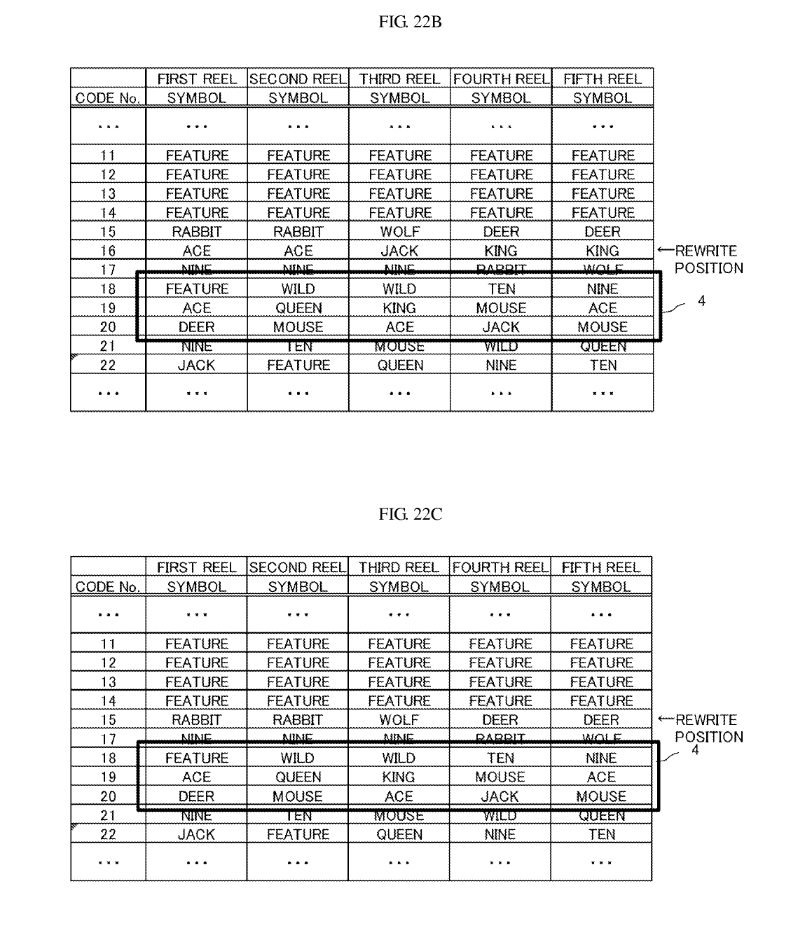

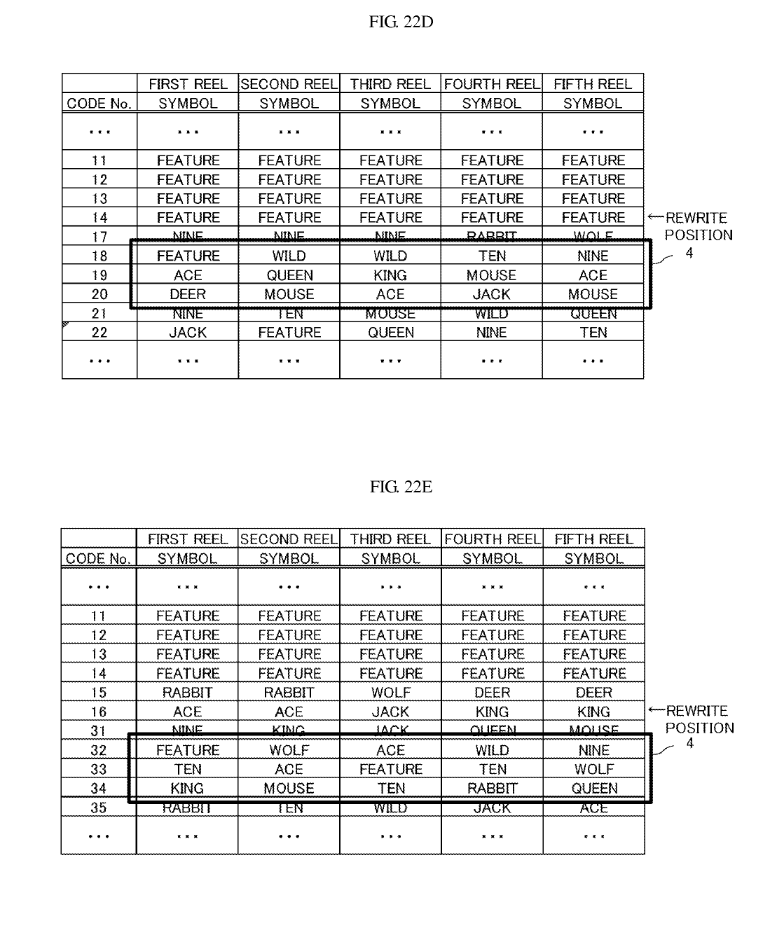

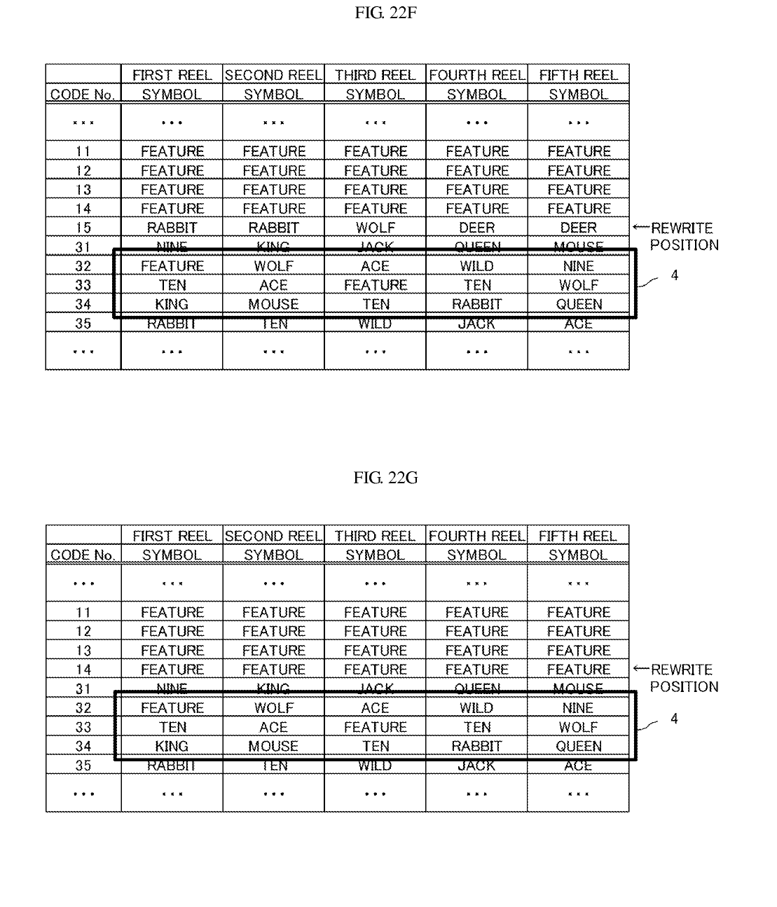

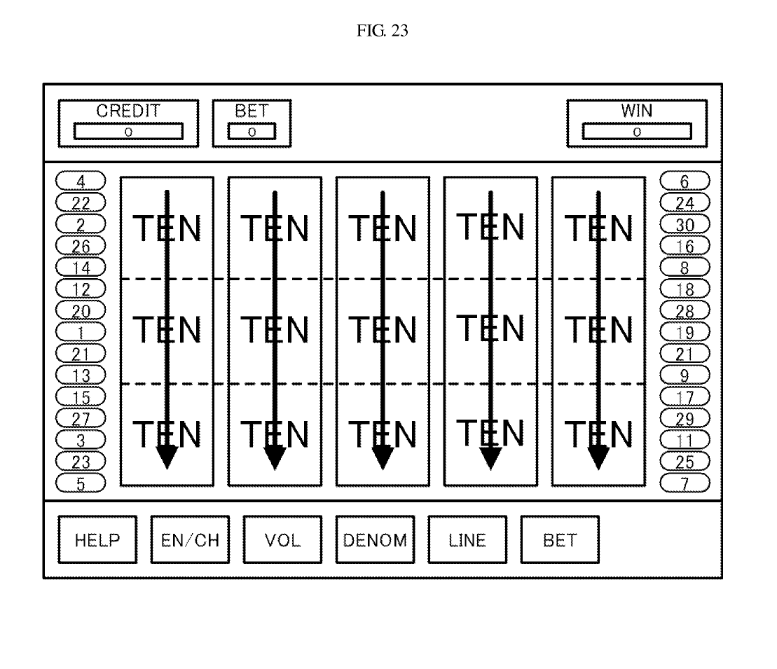

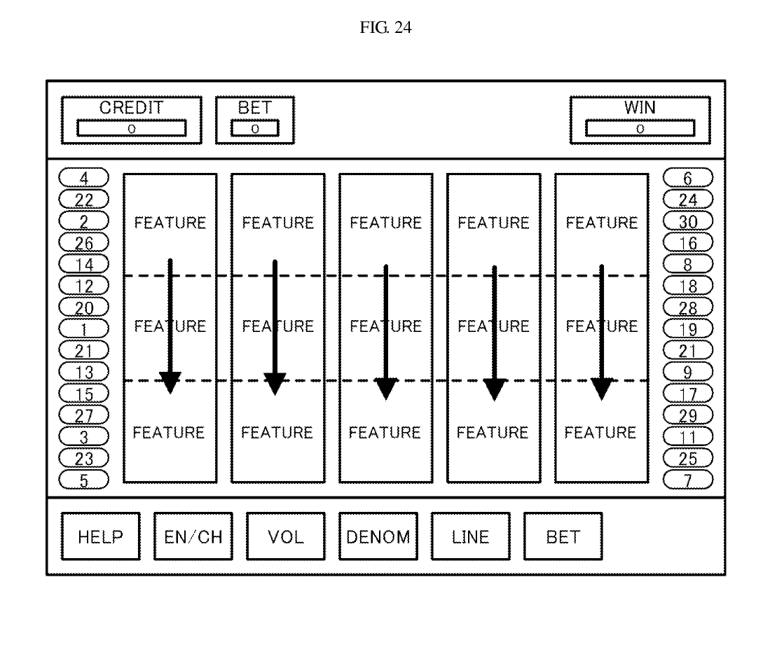

(5-1) successively placing the one kind of symbols along a scroll line in a direction away from symbols rearranged in the display region in a previous unit game, from a position away from the symbols by a predetermined number of symbols. (e.g., later-described symbol arrangements in FIGS. 22B to 22G).

According to the foregoing configuration, the one kind of symbols can be scrolled for the player to recognize them by sight after the start of scrolling. The player can recognize the existence of the one kind of symbols, feeling more expectation.

It is preferable that a gaming machine according to the present embodiment further comprise an operation button for detecting an operation of a player and outputting a start signal to start scrolling of the plurality of scroll lines,

that the processing of (1-2) include the following processing of (A-1):

(A-1) selecting one kind of symbols from the plurality kinds of symbols by lottery in response to detection of the start signal, and that the processing of (1-3) include the following processing of (A-2):

(A-2) rewriting the symbol arrays in such a manner that the one kind of symbols selected by the processing of (A-1) are successively placed along at least one of the plurality of scroll lines and storing the symbol arrays in the memory.

Furthermore, it is preferable that the processing of (2-1) include the following processing of (B-1) and (B-2):

(B-1) in a case where the one kind of symbols are not a predetermined kind of symbols, scrolling the at least one of the symbol arrays including the one kind of symbols at the predetermined speed; and

(B-2) in a case where the one kind of symbols are the predetermined kind of symbols, scrolling the at least one of the symbol arrays including the one kind of symbols at the speed different from the predetermined speed.

Still further, it is preferable that the processing of (1-3) include the following processing of (C-1):

(C-1) determining a number of the one kind of symbols to be successively placed at random.

It is to be noted that the number of the one kind of symbols to be successively placed can be determined through processing different from merely determining it at random. For example, it can be determined based on the game mode or the symbols to be rearranged determined by the processing of (1-1).

In the present embodiment, the game mode includes a base game mode and a free game mode. When the game mode is the base game mode, a greater number of one kind of symbols (for example, FEATURE symbols) to be successively placed can be determined than the number in the free game mode. One kind of symbols more likely to be rearranged lead the base game mode to be more likely to change into the free game mode (bonus game mode), providing the player with expectation. In this way, the number of the one kind of symbols to be successively placed can be determined based on the game mode.

In the meanwhile, if the symbols to be rearranged include a FEATURE symbol and the one kind of symbols are FEATURE symbols, the number of FEATURE symbols to be successively placed can be determined to be smaller than in the case of a different kind of symbols. The smaller number of FEATURE symbols to be rearranged leads the base game mode to be less likely to change to the free game mode (bonus game mode), preventing an excessive benefit from being provided to the player and securing the benefit for the game facility such as a casino. In this way, the number of one kind of symbols to be successively placed can be determined based on the determined symbols to be rearranged.

It is preferable that the processing of (B-2) include the following processing of (D-1) and (D-2):

(D-1) scrolling the at least one of the symbol arrays including the one kind of symbols at a speed slower than the predetermined speed; and

(D-2) after performing the processing of (D-1), stopping the plurality of scroll lines in substantially the same time as in a case of scrolling at the predetermined speed.

Since the time required for a unit game is substantially the same even if the symbol arrays are scrolled at a speed slower than the predetermined speed, the amount of game media consumption can be kept steady, so that the game facility such as a casino can secure their benefit. That is to say, the gaming machine controls the scrolling of the symbol arrays so that the time for a unit game will be substantially the same between in the case where the symbol arrays are scrolled at the predetermined speed and in the case where the symbol arrays are scrolled at a lower speed. In other words, it controls the scrolling of the symbol arrays from the start to the end so that the scrolling time will be constant independently of the scrolling speed. Such control can maintain steady amount of game media consumption.

It is preferable that the bonus game mode include a free game mode in which at least one unit game is conducted and a roulette game mode in which a dividend is determined by a single lottery, and that the processing of the bonus game mode include the following processing of (E-1):

(E-1) in a case where a number of unit games in the free game mode is greater than a predetermined number, allowing a player to choose either the free game mode or the roulette game mode.

The unit games in the free game mode are games that can be conducted with smaller amount of game media consumption. When the number of unit games in the free game mode is increased to some level, the time to consume smaller amount of game media increases, which may reduce the benefit for the game facility such as a casino. Accordingly, a choice of a roulette game mode is offered to the player, in which a dividend is determined by one lottery. If the player chooses the roulette game mode, the game mode can be returned to the base game mode quickly, keeping the amount of game media consumption steady.

### <<Explanation of Function Flow Diagram>>

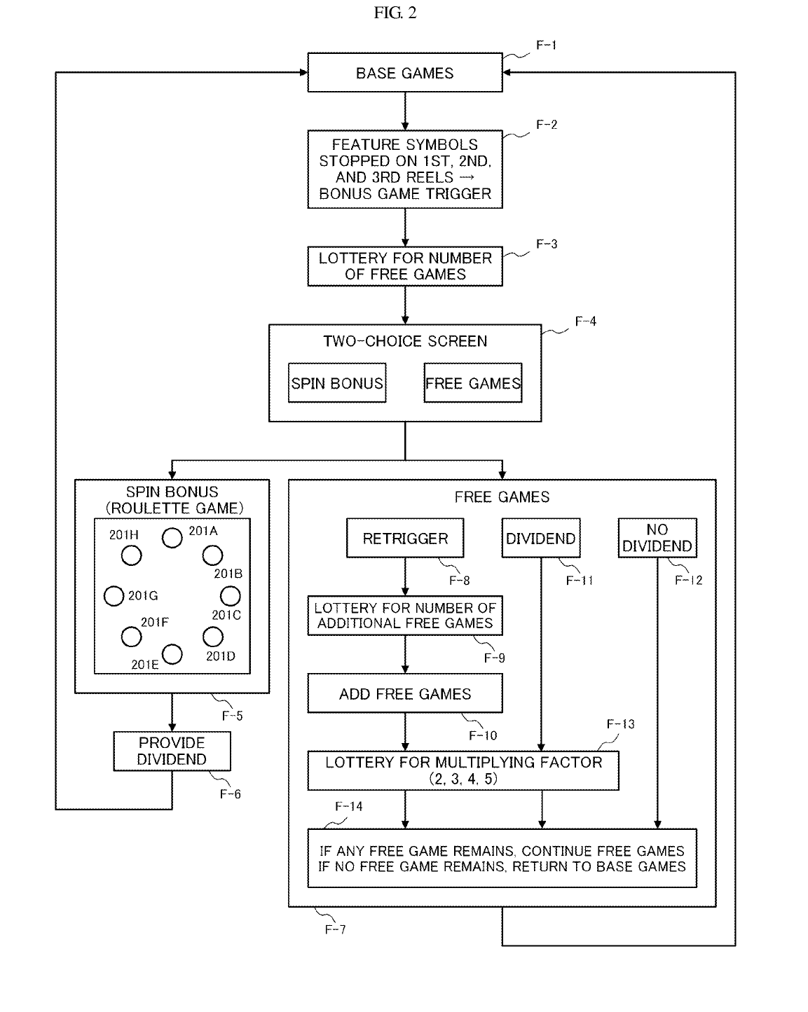

FIG. 2 is a function flow diagram illustrating basic functions of the slot machine 10 in the present embodiment. The slot machine 10 in the present embodiment has three game modes: a base game mode, a free game mode, and a roulette game mode. In the base game mode and the free game mode, the slot machine 10 conducts at least one slot game of unit game. In the roulette game mode, the slot machine 10 conducts one roulette game. In this description, the base game mode may be simply referred to as base games, the free game mode as free games, and the roulette game mode as roulette game (spin bonus). In addition, the free game mode and the roulette game mode are collectively referred to as bonus game mode.

### <Base Game Mode (Base Games)>

In the base game mode, the slot machine 10 conducts slot games (unit games). Each slot game rearranges a plurality of symbols to show a game result. Based on the rearranged symbols, an award such as a dividend is provided (F-1).

In the base game mode, rearrangement of at least one FEATURE symbol on each of the first video reel 3a, the second video reel 3b, and the third video reel 3c establishes a bonus game trigger (F-2). In the present embodiment, bonus games are games in either the free game mode or the roulette game mode.

Next, the slot machine 10 determines the number of unit games (the number of free games) after entering the free game mode by lottery (F-3).

Next, the slot machine 10 displays a screen to provide two choices of free games and a roulette game and determines either free games or a roulette game in accordance with the player's operation (F-4). The free games are games for providing slot games (unit games) as many times as the number of free games. The roulette game is a game for determining a dividend through one lottery.

### <Roulette Game Mode (Spin Bonus)>

In the case where a roulette game is chosen with the player's operation in F-4, the slot machine 10 displays images of targets 201A to 201H indicating dividends and shows them brightly one by one in the clockwise direction. That is to say, the slot machine 10 shows the image of a roulette game in such a manner that the targets 201A to 201H are illuminated brightly in the clockwise direction. Subsequently, it gradually slows down the clockwise movement and eventually stops the movement to light up the single target determined by lottery among the targets 201A to 201H (F-5).

The slot machine 10 pays out a dividend associated with the target stopped in F-5 (F-6) and returns to base games.

### <Free Game Mode>

In the case where free games are chosen in the foregoing F-4, the slot machine 10 conducts slot games (unit games) which are the same as the base games (F-7). In the free game mode, a game result is determined based on a plurality of rearranged symbols like in the base game mode.

If a retrigger is established as a result of a slot game (F-8), the slot machine 10 conducts a lottery to determine the number of additional free games (F-9) and adds the number of additional free games determined by the lottery to the current number of free games (F-10).

If a result of a slot game indicates providing a dividend (F-11), the slot machine 10 determines the dividend. If a result of a slot game indicates providing no dividend (F-12), the slot machine 10 does not determine the dividend.

In the case of providing a dividend, the slot machine further conducts a lottery to determine a multiplying factor (F-13). Subsequently, if any free game remains, the slot machine 10 continues the slot games (unit games) (F-14). If no free games remain, the game mode is returned from the free game mode to the base game mode (F-14).

### <<Overall Game System>>

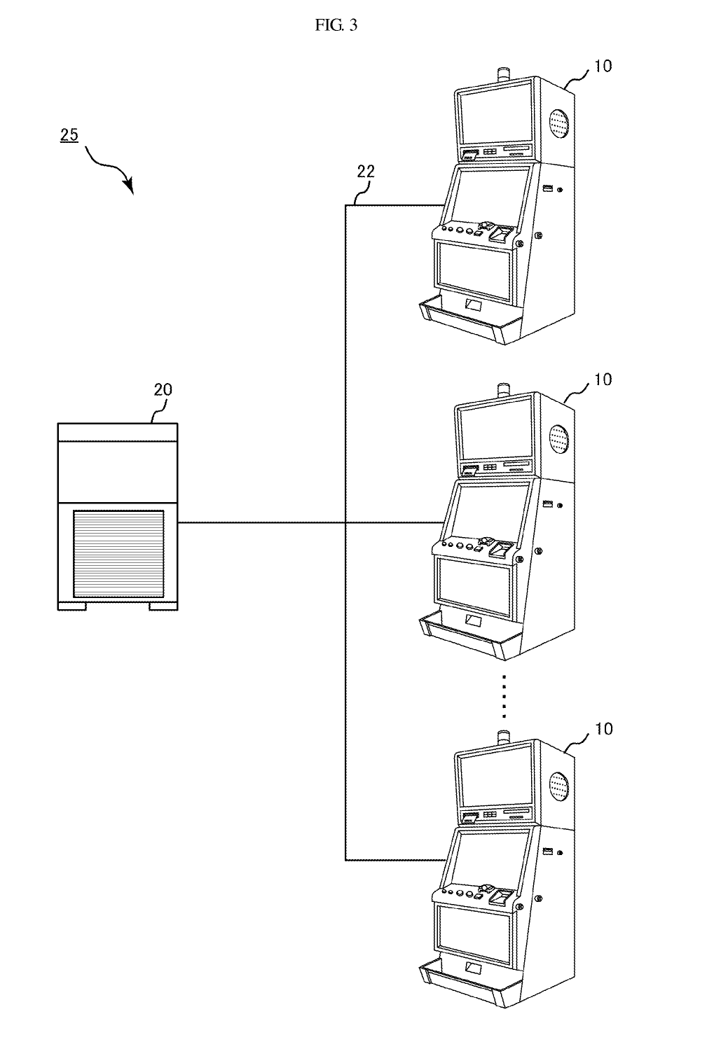

FIG. 3 is a view illustrating a general idea of the game system including the gaming machine according to the present embodiment.

A game system 25 includes a plurality of slot machines 10, and an external control device 20 that is connected to each of the slot machines 10 through a communication line 22.

The external control device 20 is for controlling the plurality of slot machines 10. In the present embodiment, the external control device 20 is a so-called hall server which is installed in a game facility having the plurality of slot machines 10. Each of the slot machines 10 is provided with a unique identification number, and the external control device 20 identifies transmission sources of data transmitted from the respective slot machines 10 by using the identification numbers. Also in the case where the external control device 20 transmits data to a slot machine 10, the identification numbers are used for specifying the transmission destination.

It is to be noted that the game system 25 may be constructed within a single game facility where various games can be conducted, such as a casino, or may be constructed among a plurality of game facilities. Further, when the game system 25 is constructed in a single game facility, the game system 25 may be constructed in each floor or section of the game facility. The communication line 22 may be a wired or wireless line, and can adopt a dedicated line, an exchange line or the like.

### <<<Configuration of Slot Machine 10>>>

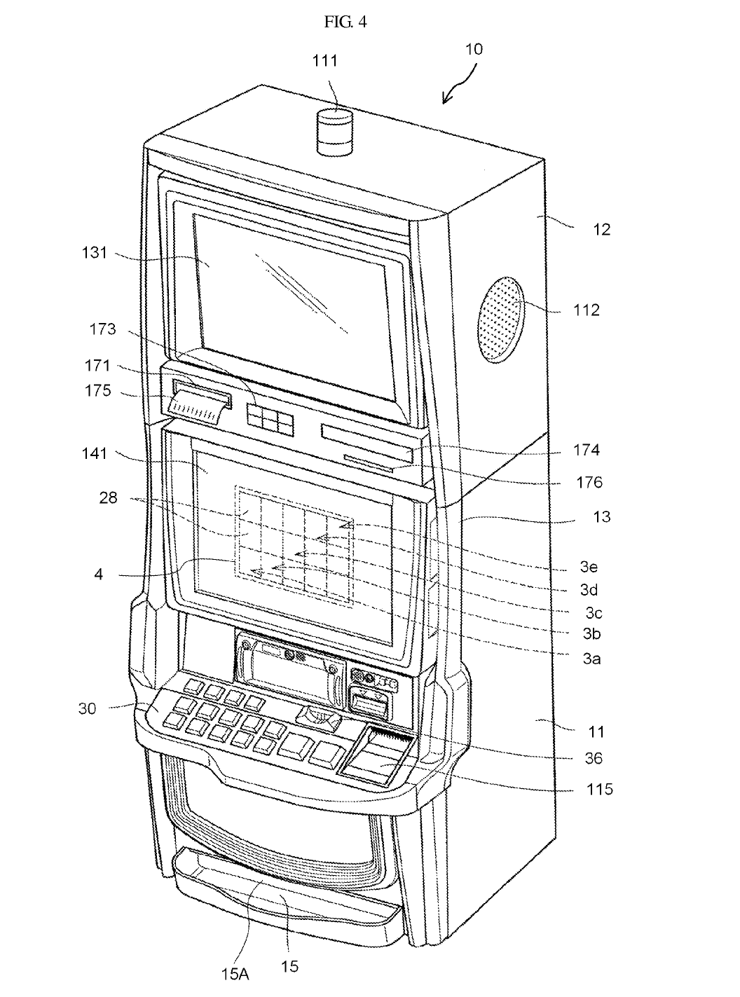

In application of the gaming machine according to the present embodiment to a slot machine 10, the slot machine 10 is described. FIG. 4 is a view illustrating an overall configuration of a slot machine 10 according to the present embodiment.

A coin, a bill, or electrically valuable information corresponding to these is used as a game medium in the slot machine 10. Further, in the present embodiment, a later-described ticket with a barcode is also used. It is to be noted that the game medium is not limited to these, and for example a medal, a token, electric money or the like can be adopted.

The slot machine 10 includes a cabinet 11, a top box 12 installed on the upper side of the cabinet 11, and a main door 13 provided at the front face of the cabinet 11.

### <Lower Image Display Panel 141>

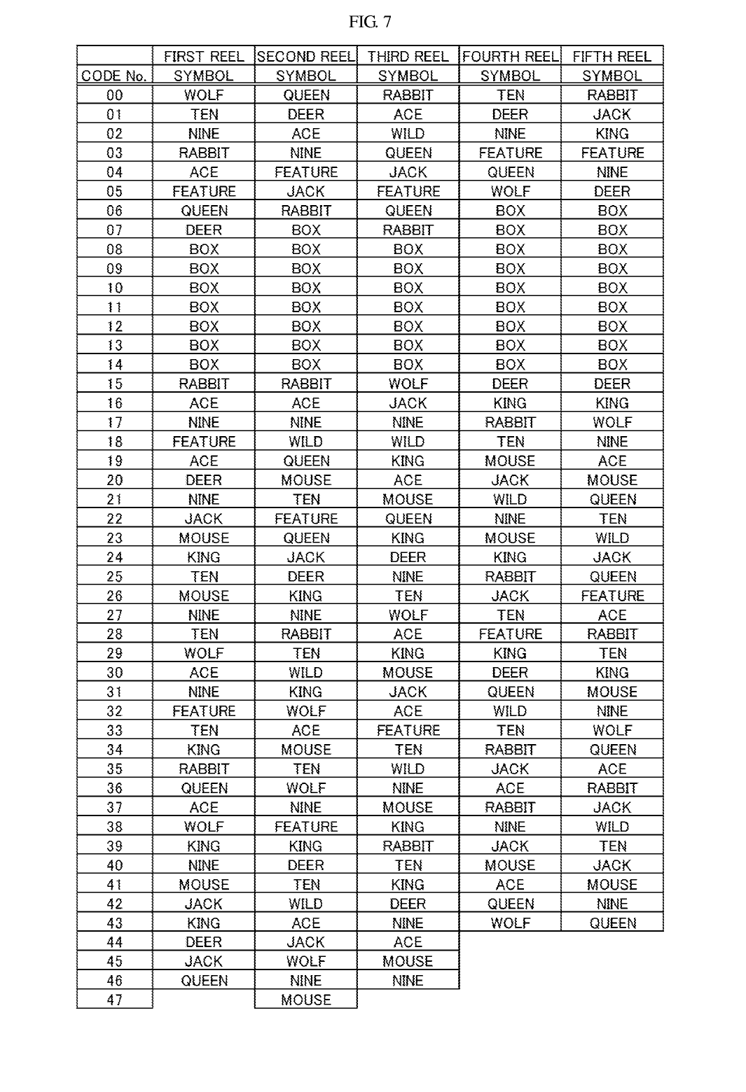

A lower image display panel 141 is provided at the center of the main door 13. The lower image display panel 141 includes a liquid crystal panel, and forms a display. The lower image display panel 141 has a symbol display region 4. In the symbol display region 4, five video reels 3 (3a, 3b, 3c, 3d, 3e) are displayed. In the present embodiment, a video reel depicts, through videos, rotational and stopping motions of a mechanical reel having a plurality of symbols drawn on the peripheral surface thereof. To each of the video reels 3, a symbol array formed of a previously determined plurality of symbols is assigned (see FIG. 7 which is described later).

In the symbol display region 4, the symbol arrays assigned to the video reels 3 are separately scrolled, and are stopped after a predetermined time has elapsed. As a result, a part of each symbol array is displayed for the player. In the present embodiment, three successive symbols along each symbol array are displayed for the player in the symbol display region 4. The three successive symbols along a symbol array are positioned in the top row, the middle row, and the bottom row. The symbol display region 4 consists of fifteen display blocks 28 of five columns×three rows. That is to say, each of the fifteen display blocks 28 shows a symbol in the symbol display region 4. In this way, symbols are rearranged in the symbol display region 4 in every unit game.

In the present embodiment, winning lines are formed by lines connecting display blocks 28. It is to be noted that any desired shape can be adopted for a winning line, and examples of the shape of the winning line may include a straight line formed by connecting the display blocks 28 in the top row in the symbol display region 4, a V-shaped line, or a bent line. In the present embodiment, the number of winning lines is 30; however, any desired number of lines can be adopted.

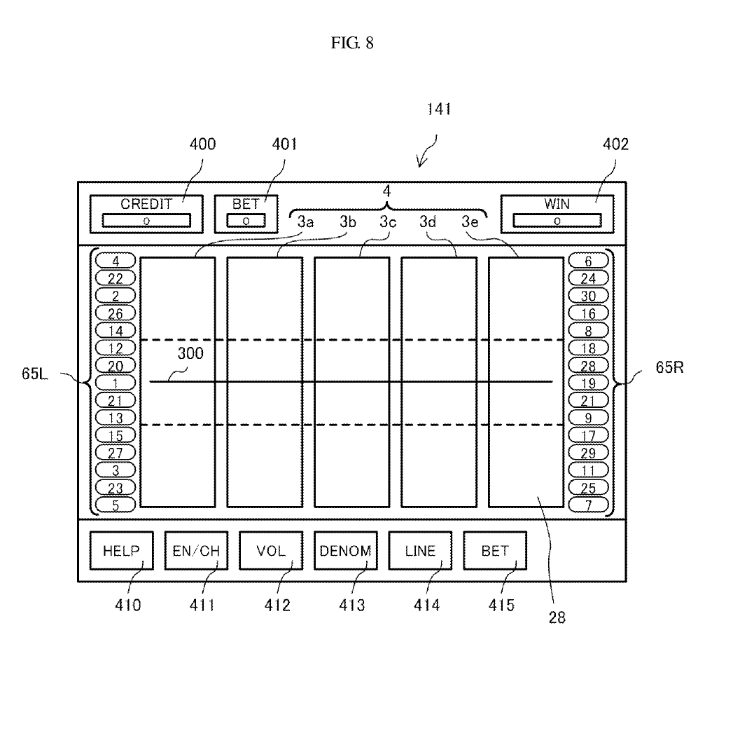

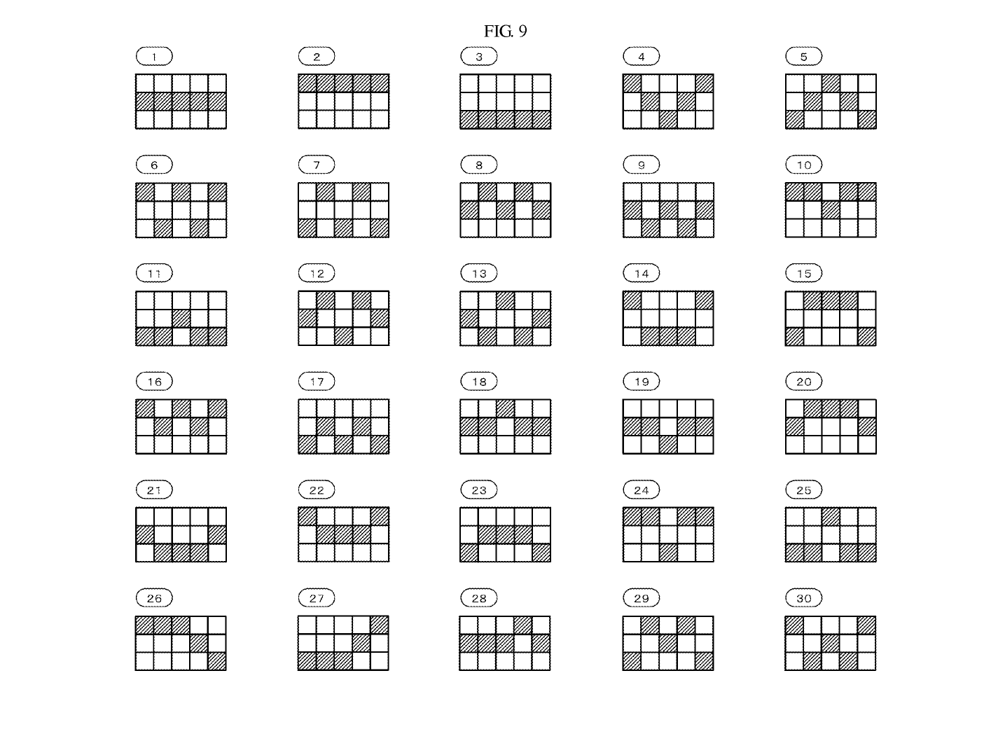

As shown in FIGS. 8 and 9, on the left side and the right side of the lower image display panel 141, payline generation columns are disposed symmetrically. The payline generation column on the left side as seen from the player has fifteen payline generation cells 65L. The right payline generation column has fifteen payline generation cells 65R. With the payline generation cells 65L and 65R, thirty paylines 300 are formed as shown in FIG. 9.

The number of valid paylines 300 is determined based on operations of later-described 1-BET button 34, 2-BET button 35, 3-BET button 37, 4-BET button 38, 5-BET button 39, MAX-BET button 45, PLAY 2 LINES button 40, PLAY 10 LINES button 41, PLAY 20 LINES button 42, and PLAY 30 LINES button 43 on the control panel 30. Depending on the enabled paylines 300, various prizes on the symbols are determined.

As shown in FIG. 8, a credit meter 400, a bet meter 401, and a win meter 402 are disposed on the upper side of the symbol display region 4. The credit meter 400 and the bet meter 401 are disposed on the left end as seen from the player. The win meter 402 is disposed on the right end as seen from the player.

The credit meter 400 indicates a total number of credits. The initial value is 0. The number increases or decreases with insertion of a game value, a bet, or a game result.

The bet meter 401 indicates a total number of bets (=bet×line). The number is recalculated at every game play. The win meter 402 incrementally indicates a total number of credits of acquired prizes. The initial value is 0. The win meter 402 switchably indicates “Line xx Win xx” and “Total Win xx”; it switches the indication together with the payline indication at occurrence of a win. The requirement to show this meter is occurrence of a win. The indication of numerical values depends on the payline at the occurrence of a win and the number of credits.

On the lower side of the symbol display region 4, a HELP touch button 410, a language switch touch button 411, a volume change touch button 412, a DENOM button 413, a number-of-lines selection touch button 414, and a bet-per-line selection touch button 415 are disposed. These buttons 410, 411, 412, 413, 414, and 415 are disposed in order from the left end to the right as seen from the player.

In response to a touch on the HELP touch button 410, a help screen appears. The HELP touch button 410 is shown dark when it is disabled, for example, when the reels are spinning. The button is shown when a normal screen is displayed.

In response to a touch on the language switch touch button 411, the language is switched between English and Chinese. The language switch touch button 411 is enabled when the display shows advertisement. It is shown dark when it is disabled, for example, when the reels are spinning.

The volume change touch button 412 is to change the game sound volume by three levels and changes the sound volume in order of LOW, MIDDLE, HIGH, LOW, MIDDLE, . . . . This button is shown when the normal screen is displayed.

The DENOM button 413 is to show a current denomination rate determined by an audit. This button appears when screens other than those for audit are displayed.

The number-of-lines selection touch button 414 is used to increase or decrease the number of paylines 300.

The bet-per-line selection touch button 415 is to permit selection of a bet per line; in response to a touch, five selection buttons in accordance with the current bet configuration appear.

On the front of the lower image display panel 141, a touch panel 114 is provided; the player can input the foregoing instructions through the buttons displayed on the lower image display panel 141. Input signals are sent from the touch panel 114 to a main CPU 71.

### <Control Panel 30>

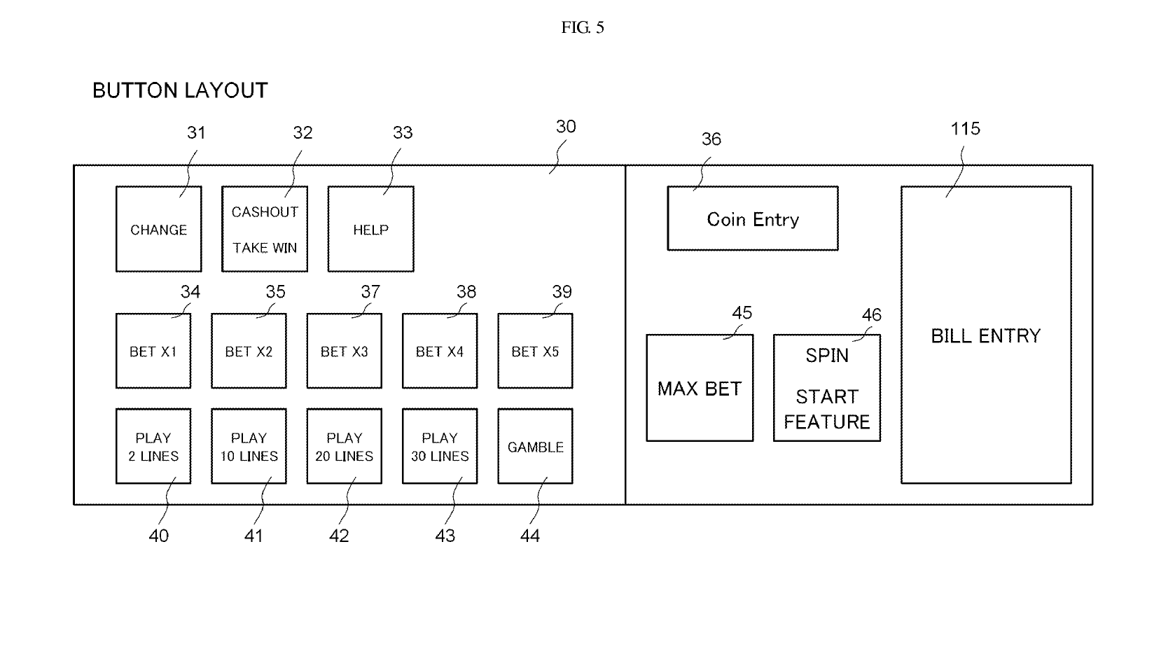

As shown in FIGS. 4 and 5, on the lower side of the lower image display panel 141, there are provided various buttons disposed on a control panel 30 (input device), as well as a coin entry 36 for receiving coins into the cabinet 11 and a bill entry 115.

On the control panel 30, a CHANGE button 31, a CASHOUT/TAKE WIN button 32, a HELP button 33 are disposed on the upper left side as seen from the player; a 1-BET button 34, a 2-BET button 35, a 3-BET button 37, a 4-BET button 38, a 5-BET button 39, a PLAY 2 LINES button 40, a PLAY 10 LINES button 41, a PLAY 20 LINES button 42, a PLAY 30 LINES button 43, and a GAMBLE button 44 are disposed on the lower left side. Furthermore, the control panel 30 includes the coin entry 36 and the bill entry 115 for receiving a bill on the upper right side as seen from the player, in addition to a MAX-BET button 45 and a SPIN button 46 provided on the lower right side.

The CHANGE button 31 is an operation button to be used when the player is leaving the slot machine 10 or requesting a game facility staff member to exchange money. The CASHOUT/TAKE WIN button 32 is an operation button to be used to pay out the coins (credit) retained inside the slot machine 10. The HELP button 33 is a button to be pressed when the player does not know how to play the game; upon press of the HELP button 33, a variety of help information is displayed on an upper image display panel 131 or the lower image display panel 141.

The 1-BET button 34 is a button to bet one credit from the credits currently owned by the player on each valid payline in response to each press. The 2-BET button 35 is a button to start a game with two bets on each valid payline. The 3-BET button 37 is a button to start a game with three bets on each valid payline; the 4-BET button 38 is a button to start a game with four bets on each valid payline; the 5-BET button 39 is a button to start a game with five bets on each valid payline; and the MAX-BET button 45 is a button to start a game with ten bets on each valid payline. Accordingly, a press of the 1-BET button 34, the 2-BET button 35, the 3-BET button 37, the 4-BET button 38, the 5-BET button 39, or the MAX-BET button 45 determines the number of BETs per valid payline.

The PLAY 2 LINES button 40 is a button to enable paylines in response to a press. A press of this button enables two paylines. The PLAY 10 LINES button 41 is a button to enable paylines in response to a press. A press of this button enables ten paylines. The PLAY 20 LINES button 42 is a button to enable paylines in response to a press. A press of this button enables twenty paylines. The PLAY 30 LINES button 43 is a button to enable paylines in response to a press. A press of this button enables thirty paylines.

The GAMBLE button 44 is an operation button to be used to enter gamble games after finishing bonus games or other games. The gamble games are conducted to spend acquired credits.

The SPIN button 46 is a button to be used to start scrolling of the video reels 3a to 3e.

The coin entry 36 is to accept coins into the cabinet 11. The bill entry 115 is to identify whether the bill is acceptable and to accept a valid bill into the cabinet 11.

An upper image display panel 131 is provided at the front face of the top box 12. The upper image display panel 131 includes a liquid crystal panel, and forms the display. The upper image display panel 131 displays images related to effects and images showing introduction of the game contents and explanation of the game rules. Further, the top box 12 is provided with a speaker 112 and a lamp 111. The slot machine 10 produces effects by displaying images, outputting sounds, and outputting the light.

A ticket printer 171, a card slot 176, a data display 174, and a keypad 173 are provided on the lower side of the upper image display panel 131.

The ticket printer 171 prints on a ticket a barcode representing encoded data of the number of credits, date, the identification number of the slot machine 10, and the like, and outputs the ticket as the ticket 175 with a barcode. The player can make a slot machine read the ticket 175 with a barcode so as to play a game thereon, and can also exchange the ticket 175 with a barcode with a bill or the like at a predetermined place (e.g. a cashier in a casino) in the game facility.

The card slot 176 is for inserting a card in which predetermined data is stored. For example, the card stores data for identifying the player, and data about the history of games played by the player. When the card is inserted into the card slot 176, a later-described card reader 172 reads data from the card or writes data into the card. It is to be noted that the card may store data corresponding to a coin, a bill or a credit.

The data display 174 includes a fluorescent display, LEDs and the like, and displays the data read by the card reader 172 or the data inputted by the player via the keypad 173, for example. The keypad 173 is for inputting a command and data related to ticket issuance or the like.

In this description, the gaming machine according to an embodiment of the present invention controls the display of video reels on the display device; however, the gaming machine may be a type of gaming machine in which a stepping motor drives mechanical reels to show symbols to the player.

### <<Symbol Arrays of Video Reels>>

FIG. 7 is a view illustrating symbol arrays of five video reels 3a to 3e of the slot machine 10.

As shown in FIG. 7, the first video reel 3a is assigned a symbol array consisting of 47 symbols corresponding to code Nos. 00 to 46 in the present embodiment. The second video reel 3b is assigned a symbol array consisting of 48 symbols corresponding to code Nos. 00 to 47; the third video reel 3c is assigned a symbol array consisting of 47 symbols corresponding to code Nos. 00 to 46; the fourth video reel 3d is assigned a symbol array consisting of 44 symbols corresponding to code Nos. 00 to 43; and the fifth video reel 3e is assigned a symbol array consisting of 44 symbols corresponding to code Nos. 00 to 43.

In this way, the code numbers are the numbers for indicating the positions of the symbols along the symbol array disposed on each of the first video reel 3a to the fifth video reel 3e.

As shown in FIG. 7, the symbols have the kinds of JACK, QUEEN, KING, NINE, ACE, TEN, MOUSE, RABBIT, DEER, WOLF, WILD, FEATURE, and BOX. The BOX symbols correspond to random symbols; although details thereof will be described later, the symbols to be displayed for the BOX symbols are determined by lottery in each unit game. The BOX symbols will be described later. Each of these kinds of symbols is assigned a symbol code. Designation of one symbol code identifies a kind of symbols.

A RAM 73 stores a symbol table defining the symbol arrays shown in FIG. 7. For each of the first video reel 3a to the fifth video reel 3e, association relations between code numbers and symbol codes are stored in the symbol table. Accordingly, the symbol table searched with designation of a reel number out of the first to the fifth video reels 3a to 3e and a code number can provide one corresponding symbol code. The symbol code identifies the symbol.

As will be described later, the plurality of cells denoted by BOX (aforementioned BOX symbols) in FIG. 7 show the same kind of symbols in the present embodiment.

### <<Configuration of Circuit Included in Gaming Machine>>

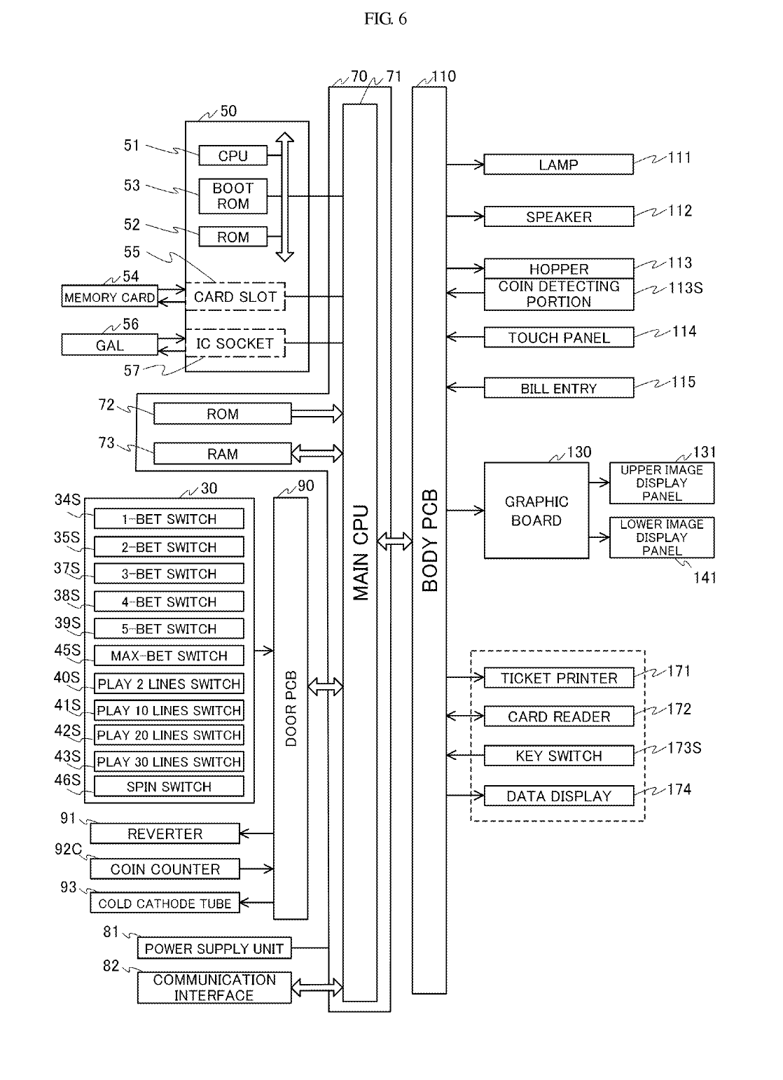

FIG. 6 is a block diagram illustrating an internal configuration of the slot machine 10 in the present embodiment.

A gaming board 50 is provided with: a CPU 51, a ROM 52, and a boot ROM 53, which are mutually connected by an internal bus; a card slot 55 corresponding to a memory card 54; and an IC socket 57 corresponding to a GAL (Generic Array Logic) 56.

The memory card 54 includes a non-volatile memory, and stores a game program and a game system program. The game program includes a program related to game progression, a lottery program, and a program for producing effects by images and sounds (e.g. see FIGS. 13 to 20 which are described later). Further, the aforementioned game program includes data (see FIG. 7) specifying the configuration of the symbol array assigned to each video reel 3.

The lottery program is a program for determining to-be stopped symbols of each video reel 3 by lottery. The to-be stopped symbol is data for determining three symbols to be displayed to the symbol display region 4 out of the symbols forming each symbol array. Specifically, in the case of the first video reel 3a, three symbols are determined out of 47 symbols forming the first video reel 3a to be the to-be stopped symbols. In the case of the second video reel 3b, three symbols are determined out of 48 symbols forming the second video reel 3b to be the to-be stopped symbols. In the case of the third video reel 3c, three symbols are determined out of 47 symbols forming the third video reel 3c to be the to-be stopped symbols. In the case of the fourth video reel 3d, three symbols are determined out of 44 symbols forming the fourth video reel 3d to be the to-be stopped symbols. In the case of the fifth video reel 3e, three symbols are determined out of 44 symbols forming the fifth video reel 3e to be the to-be stopped symbols.

It is to be noted that the lottery program of the slot machine 10 in the present embodiment needs to determine one symbol to be shown in a predetermined section (e.g. the top row) of the symbol display region 4 for the to-be stopped symbol. That is to say, the lottery program determines, for each of the first video reel 3a to the fifth video reel 3e, one symbol to be shown in the top row of the symbol display region 4 for a to-be stopped symbol. Through this processing, five symbols are determined for to-be stopped symbols. It is to be further noted that the lottery program determines a code number (see FIG. 7) for the to-be stopped symbol on each of the first video reel 3a to the fifth video reel 3e.

The aforementioned lottery program includes symbol determination data. The symbol determination data defines random values so as to determine each of the symbols forming the symbol array at an equal probability, for each video reel 3.

Specifically, in the case of the first video reel 3a, each of the 47 symbols forming the first video reel 3a is determined at an equal probability (1/47). In the case of the second video reel 3b, each of the 48 symbols forming the second video reel 3b is determined at an equal probability (1/48). In the case of the third video reel 3c, each of the 47 symbols forming the third video reel 3c is determined at an equal probability (1/47). In the case of the fourth video reel 3d, each of the 44 symbols forming the fourth video reel 3d is determined at an equal probability (1/44). In the case of the fifth video reel 3e, each of the 44 symbols forming the fifth video reel 3e is determined at an equal probability (1/44).

As noted above, the probabilities that the individual symbols are determined are basically equal. However, the numbers of the same kinds of symbols included in the symbol arrays are different among the first video reel 3a to the fifth video reel 3e. Accordingly, the probabilities to determine the individual kinds of symbols are different (i.e. different weights on the probabilities are generated).

For example, with reference to FIG. 7, the symbol array of the first video reel 3a includes three symbols of WOLF and includes five symbols of ACE. Hence, the former is determined at the probability of 3/47, whereas the latter is determined at the probability of 5/47.

It is to be noted that, although the data in the present embodiment is defined in such a configuration that different numbers of symbols form the symbol arrays of the video reels 3, the same numbers of symbols may form the video reels 3.

Further, the card slot 55 is configured so that the memory card 54 can be inserted thereinto and removed therefrom, and is connected to a motherboard 70 by an IDE bus.

The GAL 56 is a type of PLD (Programmable Logic Device) having a fixed OR array structure. The GAL 56 is provided with a plurality of input ports and output ports, and predetermined input into the input port causes output of the corresponding data from the output port.

Further, the IC socket 57 is configured so that the GAL 56 can be inserted thereinto and removed therefrom, and is connected to the motherboard 70 by a PCI bus. The contents of the game to be played on the slot machine 10 can be changed by replacing the memory card 54 with another memory card 54 having another program written therein or by rewriting the program written into the memory card 54 as another program.

The CPU 51, the ROM 52 and the boot ROM 53 mutually connected by the internal bus are connected to the motherboard 70 by a PCI bus. The PCI bus enables a signal transmission between the motherboard 70 and the gaming board 50, and power supply from the motherboard 70 to the gaming board 50.

The ROM 52 stores an authentication program. The boot ROM 53 stores a pre-authentication program, a program (boot code) to be used by the CPU 51 for activating the pre-authentication program, and the like. The authentication program is a program (tamper check program) for authenticating the game program and the game system program. The pre-authentication program is a program for authenticating the aforementioned authentication program. The authentication program and the pre-authentication program are written along a procedure (authentication procedure) for proving that the program to be the subject has not been tampered.

The motherboard 70 is provided with a main CPU 71, a ROM 72, a RAM 73, and a communication interface 82.

The ROM 72 includes a memory device such as a flash memory, and stores a program such as BIOS to be executed by the main CPU 71, and permanent data. When the BIOS is executed by the main CPU 71, processing for initializing predetermined peripheral devices is conducted; further, through the gaming board 50, processing of loading the game program and the game system program stored in the memory card 54 is started.

The RAM 73 stores data and programs which are used in operation of the main CPU 71. For example, when the processing of loading the aforementioned game program, game system program or authentication program is conducted, the RAM 73 can store the program. The RAM 73 is provided with working areas used for operations in execution of these programs. Examples of the areas include: an area that stores the number of games, the number of BETs, the number of payouts, the number of credits and the like; and an area that stores symbols (code numbers) determined by lottery.

The communication interface 82 is for communicating with the external control device 20 such as a server, through the communication line 22. Further, the motherboard 70 is connected with a later-described door PCB (Printed Circuit Board) 90 and a body PCB 110 by respective USBs. The motherboard 70 is also connected with a power supply unit 81. When the power is supplied from the power supply unit 81 to the motherboard 70, the main CPU 71 of the motherboard 70 is activated, and then the power is supplied to the gaming board 50 through the PCI bus so as to activate the CPU 51.

The door PCB 90 and the body PCB 110 are connected with input devices such as a switch and a sensor, and peripheral devices the operations of which are controlled by the main CPU 71. The door PCB 90 is connected with a control panel 30, a reverter 91, a coin counter 92C and a cold cathode tube 93.

The control panel 30 is provided with a 1-BET switch 34S, a 2-BET switch 35S, a 3-BET switch 37S, a 4-BET switch 38S, a 5-BET switch 39S, a MAX-BET switch 45S, a PLAY 2 LINES switch 40S, a PLAY 10 LINES switch 41S, a PLAY 20 LINES switch 42S, a PLAY 30 LINES switch 43S, and a SPIN switch 46S, which correspond to the aforementioned respective buttons. Each of the switches outputs a signal to the main CPU 71 upon detection of press of the button corresponding thereto by the player.

The coin counter 92C validates a coin inserted into the coin entry 36 based on its material, shape and the like, and outputs a signal to the main CPU 71 upon detection of a valid coin. Invalid coins are discharged from a coin payout exit 15A.

The reverter 91 operates based on a control signal outputted from the main CPU 71, and distributes valid coins validated by the coin counter 92C into a hopper 113 or a cash box (not illustrated). That is, coins are distributed into the hopper 113 when the hopper 113 is not filled with coins, while coins are distributed into the cash box when the hopper 113 is filled with coins.

The cold cathode tube 93 functions as a backlight installed on the rear face sides of the upper image display panel 131 and the lower image display panel 141, and lights up based on a control signal outputted from the main CPU 71.

The body PCB 110 is connected with the lamp 111, the speaker 112, the hopper 113, a coin detecting portion 113S, the touch panel 114, the bill entry 115, a graphic board 130, the ticket printer 171, the card reader 172, a key switch 173S and the data display 174.

The lamp 111 lights up based on a control signal outputted from the main CPU 71. The speaker 112 outputs sounds such as BGM, based on a control signal outputted from the main CPU 71.

The hopper 113 operates based on a control signal outputted from the main CPU 71, and pays out coins of the specified number of payouts from the coin payout exit 15A to the coin tray 15. The coin detecting portion 113S outputs a signal to the main CPU 71 upon detection of coins paid out by the hopper 113.

The touch panel 114 detects a place on the lower image display panel touched by the player's finger or the like, and outputs to the main CPU 71 a signal corresponding to the detected place. In similar, the upper image display panel 131 may include a touch panel. Upon acceptance of a valid bill, the bill entry 115 outputs to the main CPU 71 a signal corresponding to the face amount of the bill.

The graphic board 130 controls display of images conducted by the respective upper image display panel 131 and lower image display panel 141, based on a control signal outputted from the main CPU 71. The symbol display region 4 of the lower image display panel 141 displays the five video reels 3 by which the scrolling (moving) and stop motions of the symbol arrays included in the respective video reels 3 are displayed. The graphic board 130 is provided with a VDP generating image data, a video RAM temporarily storing the image data generated by the VDP, and the like. The credit meter 400 of the lower image display panel 141 displays the number of credits stored in the RAM 73. The win meter 402 of the lower image display panel 141 displays the number of payouts of coins.

The graphic board 130 is provided with the VDP (Video Display Processor) generating image data based on a control signal outputted from the main CPU 71, the video RAM temporarily storing the image data generated by the VDP, and the like. It is to be noted that the image data used in generation of image data by the VDP is included in the game program that has been read from the memory card 54 and stored into the RAM 73.

Based on a control signal outputted from the main CPU 71, the ticket printer 171 prints on a ticket a barcode representing encoded data of the number of credits stored in the RAM 73, date, the identification number of the slot machine 10, and the like, and then outputs the ticket as the ticket 175 with a barcode.

The card reader 172 reads data stored in a card inserted into the card slot 176 and transmits the data to the main CPU 71, or writes data into the card based on a control signal outputted from the main CPU 71.

The key switch 173S is provided in the keypad 173, and outputs a predetermined signal to the main CPU 71 when the keypad 173 has been operated by the player.

The data display 174 displays data read by the card reader 172 and data inputted by the player through the keypad 173, based on a control signal outputted from the main CPU 71.

### <<Number-of-Payouts Determination Table>>

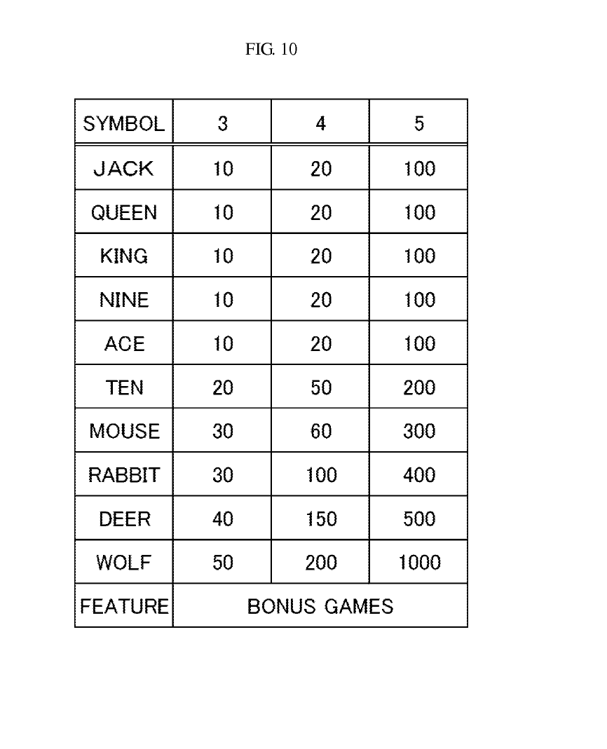

FIG. 10 is a table showing a specific example of a number-of-payouts determination table. The number-of-payouts determination table is stored in a predetermined storage area of the ROM 72 on the mother board 70.

The number-of-payouts determination table stores correspondence relations between combinations of the types and the numbers of symbols rearranged along an enabled payline 300 and the numbers of credits to be paid out for the combinations. The number-of-payouts determination table is retrieved and referred to in step S18 in FIG. 13 or step S1825 in FIG. 18. In the present embodiment, when three or more symbols of at least one kind out of JACK, QUEEN, KING, NINE, ACE, TEN, MOUSE, RABBIT, DEER, and WOLF are rearranged along a valid payline 300, winning in the game is determined.

For example, with reference to FIG. 10, when three JACK symbols are rearranged along a valid payline 300, the dividend is determined to be 10. When five DEER symbols are rearranged along a valid payline 300, the dividend is determined to be 500.

When one or more FEATURE symbols are rearranged on each of 1st, 2nd, and 3rd reels, bonus games are provided. When at least one FEATURE symbol is rearranged in a display block 28 on each of the first video reel 3a, the second video reel 3b, and the third video reel 3c, a bonus game trigger is established. The establishment of the bonus game trigger changes the game mode from a base game mode into a bonus game mode. In the present embodiment, the bonus game mode includes the free game mode and the roulette game mode.

### <<Number-of-Free-Games Determination Lottery Table>>

FIG. 11 is a table showing an example of a number-of-free-games determination lottery table. The number-of-free-games determination lottery table is stored in a predetermined storage area of the ROM 72 on the mother board 70.

The number-of-free-games determination lottery table indicates the winning probabilities of numbers of free games associated with the numbers of FEATURE symbols shown in the symbol display region 4. As a result of a unit game (slot game) in the base game mode or the free game mode, FEATURE symbols may be rearranged. With reference to the number-of-free-games determination lottery table, the number of unit games in the free game mode (the number of free games) is determined in accordance with the number of rearranged FEATURE symbols. FIG. 11 indicates the numbers of FEATURE symbols in the header row and the number of free games in the header column.

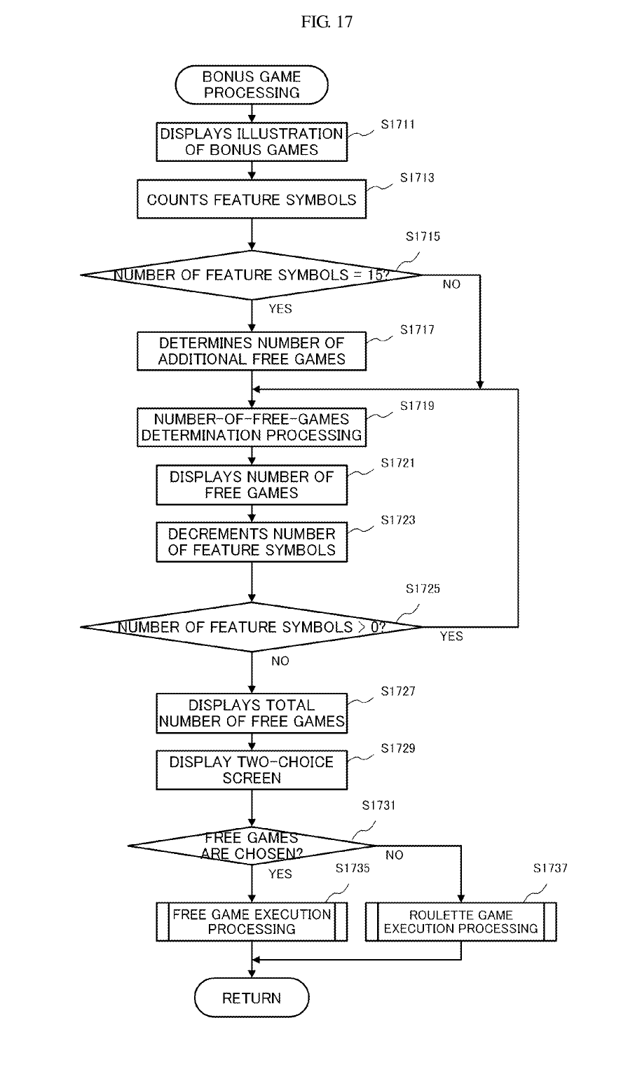

As will be described later, when a bonus game trigger is established in step S19 in the main control processing illustrated in FIG. 13, the subroutine of bonus game processing illustrated in FIG. 17 is invoked and executed. In step S1719 in this bonus game processing, the number-of-free-games determination lottery table is referred to and the number of free games is determined. Also in step S1829 in FIG. 18, the number-of-free-games determination lottery table is referred to and the number of free games is determined. In the case of free game execution processing, the determined number of free games are added.

For example, when, in the base game mode, one FEATURE symbol is rearranged in a display block 28 of each of the first video reel 3a, the second video reel 3b, and the third video reel 3c, or when three FEATURE symbols in total are rearranged in the symbol display region 4, the main CPU 71 determines that a bonus game trigger is established in step S19 in the main control processing. When the bonus game trigger is established, the main CPU 71 refers to the column of Very_Low in the number-of-free-games determination lottery table in step S1719 in bonus game processing. In this case, “3” free games are determined with a probability of 50/100; “6” free games are determined with a probability of 30/100; “9” free games are determined with a probability of 10/100; “12” free games are determined with a probability of 7/100; “15” free games are determined with a probability of 2/100; and “30” free games are determined with a probability of 1/100.

In the present embodiment, the winning probabilities are defined in such a manner that the number of free games increases as the number of FEATURE symbols rearranged in the symbol display region 4 increases.

Specifically, depending on the number of FEATURE symbols rearranged in the symbol display region 4, six ranks of probabilities, Very_Low, Low, Middle, High, Very_High, and EXTRA, are provided. The expectation values for the number of free games to be attained are defined to be greater as the number of FEATURE symbols rearranged in the symbol display region 4 is greater.

### <<Roulette Game Dividend Table>>

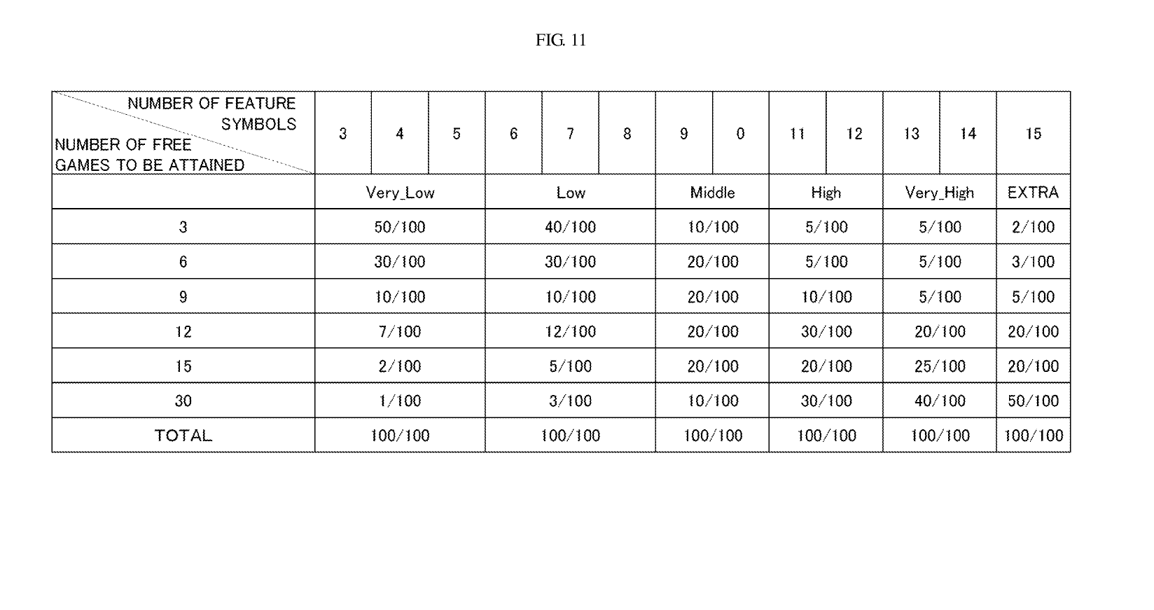

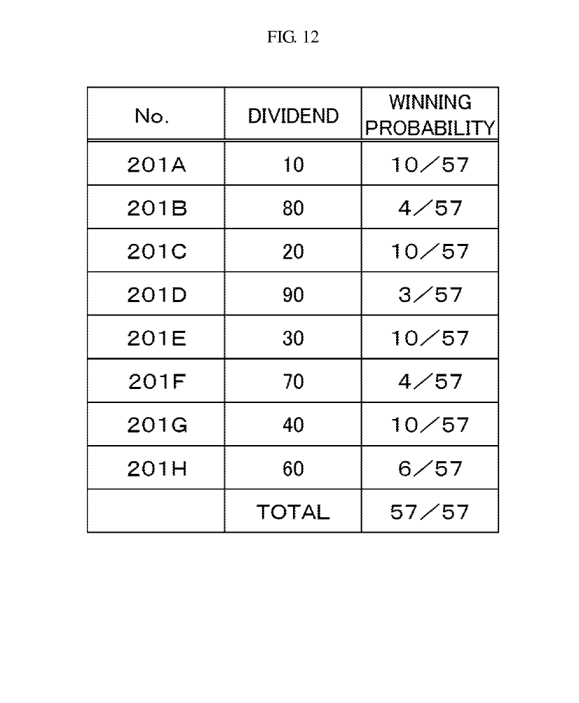

FIG. 12 is a table showing an example of a roulette game dividend table. The roulette game dividend table is stored in a predetermined storage area in the ROM 72 on the mother board 70.

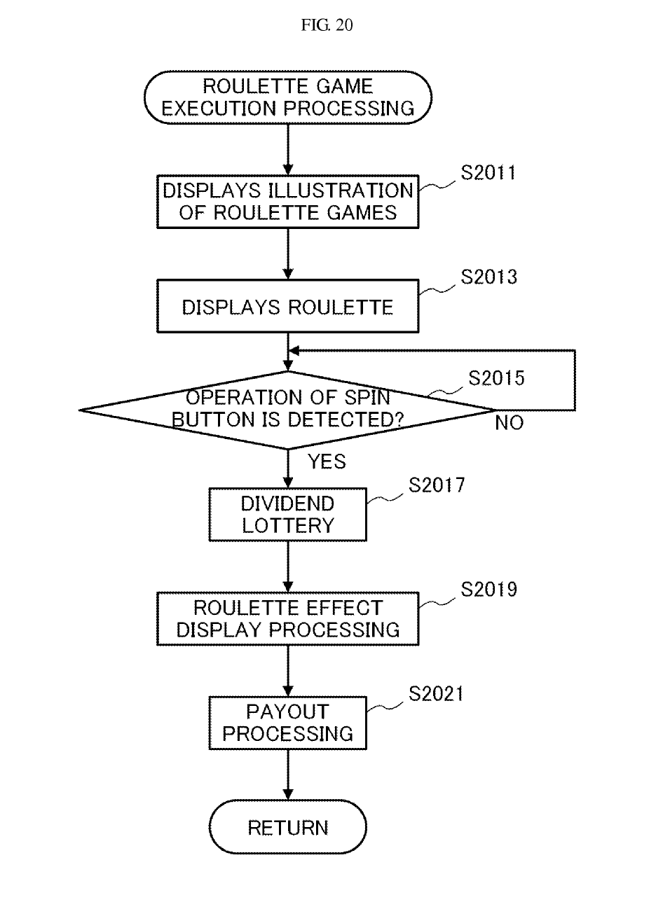

The roulette game dividend table is dividend data retrieved and referred to in step S2017 in FIG. 20 illustrating a subroutine of roulette game execution processing. As shown in FIG. 2, the roulette image shows eight targets 201A to 201H. The roulette game dividend table defines winning probabilities of dividends for the eight targets 201A to 201H.

Specifically, as shown in FIG. 12, the target 201A is assigned a dividend of “10 credits” and the winning probability is specified at “10/57”. The target 201B is assigned a dividend of “80 credits” and the winning probability is specified at “4/57”. The target 201C is assigned a dividend of “20 credits” and the winning probability is specified at “10/57”. The target 201D is assigned a dividend of “90 credits” and the winning probability is specified at “3/57”. The target 201E is assigned a dividend of “30 credits” and the winning probability is specified at “10/57”. The target 201F is assigned a dividend of “70 credits” and the winning probability is specified at “4/57”. The target 201G is assigned a dividend of “40 credits” and the winning probability is specified at “10/57”. The target 201H is assigned a dividend of “60 credits” and the winning probability is specified at “6/57”.

### <<Control Processing>>

Hereinafter, control programs executed in the slot machine 10 will be described.

### <Main Control Processing>

FIG. 13 is a view illustrating a flowchart of the main control processing for the slot machine 10 in the present embodiment.

First, when the power is supplied to the slot machine 10, the main CPU 71 reads the authenticated game program and game system program from the memory card 54 through the gaming board 50, and writes the programs into the RAM 73 (step S11).

Next, the main CPU 71 conducts at-one-game-end initialization processing (step S12). For example, data that becomes unnecessary after each game in the working areas of the RAM 73, such as the number of BETs and the symbols determined by lottery, is cleared.

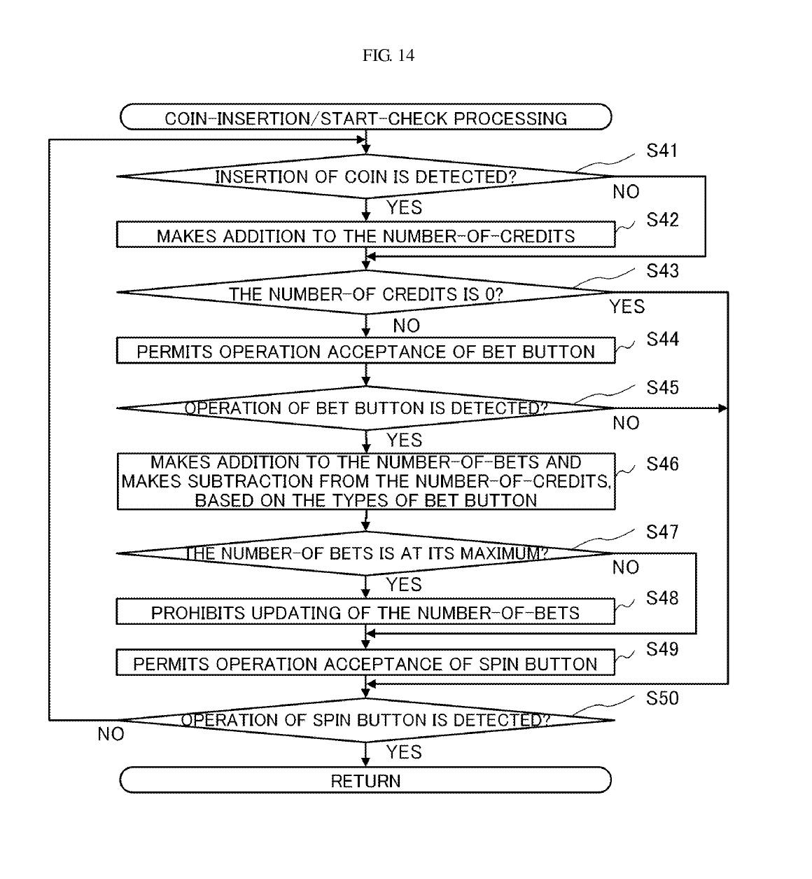

Next, the main CPU 71 invokes and conducts coin-insertion/start-check processing which is described later with reference to FIG. 14 (step S13). This processing includes checking whether input from the 1-BET switch 34S, the 2-BET switch 35S, the 3-BET switch 37S, the 4-BET switch 38S, the 5-BET switch 39S, the MAX-BET switch 45S, the PLAY 2 LINES switch 40S, the PLAY 10 LINES switch 41S, the PLAY 20 LINES switch 42S, the PLAY 30 LINES switch 43S, and the SPIN switch 46S properly works.

The main CPU 71 then conducts symbol lottery processing (step S15). In the processing, to-be stopped symbols are determined based on the random values for symbol determination.

Specifically, the main CPU 71 extracts five random values of the first to fifth random values for symbol determination. Next, the main CPU 71 determines a to-be stopped symbol for the first video reel 3a with the first random value, a to-be stopped symbol for the second video reel 3b with the second random value, a to-be stopped symbol for the third video reel 3c with the third random value, a to-be stopped symbol for the fourth video reel 3d with the fourth random value, and a to-be stopped symbol for the fifth video reel 3e with the fifth random value. The determined to-be stopped symbols for the first to the fifth video reels 3a to 3e are stored in a symbol storage area provided in the RAM 73.

Next, the main CPU 71 invokes and conducts a subroutine of symbol rewrite processing which is described later with reference to FIG. 15 (step S14). This symbol rewrite processing partially rewrites the symbols placed on each of the first video reel 3a, the second video reel 3b, the third video reel 3c, the fourth video reel 3d, and the fifth video reel 3e.

Next, the main CPU 71 conducts effect contents determination processing (step S16). The main CPU 71 extracts a random value for effect, and determines any of the effect contents from the preset plurality of effect contents by lottery.

The main CPU 71 then invokes and conducts a subroutine of symbol display control processing which is described later with reference to FIG. 16 (step S17). In the processing, scrolling of the symbol arrays formed of the symbols placed on the first video reel 3a, the second video reel 3b, the third video reel 3c, the fourth video reel 3d, and the fifth video reel 3e is started. After a predetermined time has elapsed since the start of scrolling, the scrolling is stopped. The scrolling is stopped in such a manner that the to-be stopped symbols determined in the symbol lottery processing of step S15 are stopped at predetermined positions (e.g. the top row in the symbol display region 4). That is, fifteen symbols including the to-be stopped symbols are displayed in the symbol display region 4. In this way, rearrangement of symbols is performed.

Next, the main CPU 71 conducts number-of-payouts determination processing (step S18). In the processing, the number of payouts is determined based on the symbols rearranged along valid paylines 300 with reference to the number-of-payouts determination table (FIG. 10) stored in the ROM 72. The determined number of payouts is stored into a number-of-payouts storage area provided in the RAM 73.

The main CPU 71 then determines whether a bonus game trigger has been established (step S19). The bonus game trigger to enter the bonus games in the present embodiment is that at least one FEATURE symbol is rearranged on each of the first video reel 3a, the second video reel 3b, and the third video reel 3c.

Accordingly, even if three FEATURE symbols are rearranged on the first video reel 3a and three FEATURE symbols are rearranged on the second video reel 3b, the bonus game trigger is not established unless at least one FEATURE symbol is rearranged on the third video reel 3c.

When determining in step S19 that the bonus game trigger has been established (YES), the main CPU 71 invokes and conducts a subroutine of bonus game processing which is described later (step S20).

After executing step S20 or when determining in step S19 that the bonus game trigger has not been established (NO), the main CPU 71 determines whether any dividend is to be provided for the rearrangement of the symbols (step S21). This is to determine whether a dividend is to be provided in accordance with the forgoing number-of-payouts determination processing in step S18.

When determining in step S21 that a dividend is to be provided (YES), the main CPU 71 conducts payout processing (step S22). The main CPU 71 adds the value stored in the number-of-payouts storage area to a value stored in the number-of-credits storage area provided in the RAM 73.

It is to be noted that operations of the hopper 113 may be controlled based on input from the CASHOUT switch 33S, and coins corresponding to the value of the number of payouts stored in the number-of-payouts storage area may be discharged to the coin tray 15.

After executing step S22 or when determining in Step 21 that no dividend is to be provided (NO), the main CPU 71 returns the processing to step S12.

### <Coin-Insertion/Start-Check Processing>

FIG. 14 is a flowchart of the coin-insertion/start-check processing. The coin-insertion/start-check processing is invoked in step S13 of the main control processing in FIG. 13.

First, the main CPU 71 determines whether or not insertion of a coin has been detected by the coin counter 92C (step S41).

When determining that the insertion of a coin has been detected (YES), the main CPU 71 makes an addition to the value stored in the number-of-credits storage area (step S42). It is to be noted that the main CPU 71 may determine whether or not insertion of a bill has been detected by the bill entry 115, and when determining that the insertion of a bill has been detected, the main CPU 71 adds a value according to the bill to the value stored in the number-of-credits storage area.

After step S42 or when determining in step S41 that the insertion of a coin has not been detected (NO), the main CPU 71 determines whether or not the value stored in the number-of-credits storage area is zero (step S43).

When determining that the value stored in the number-of-credits storage area is not zero (NO), the main CPU 71 permits operation acceptance of the BET buttons (the 1-BET button 34, the 2-BET button 35, the 3-BET button 37, the 4-BET button 38, the 5-BET button 39, and the MAX-BET button 45) (step S44). It is to be noted that the main CPU 71 further permits operation acceptance of the payline buttons (the PLAY 2 LINES button 40, the PLAY 10 LINES button 41, the PLAY 20 LINES button 42, and the PLAY 30 LINES button 43). The permission of operation acceptance of the payline buttons allows the player to enable a desired number of paylines 300.

Next, the main CPU 71 determines whether or not operation of any of the BET buttons has been detected (step S45). When the main CPU 71 determines that the BET switch (the 1-BET switch 34S, the 2-BET switch 35S, the 3-BET switch 37S, the 4-BET switch 38S, the 5-BET switch 39S, or the MAX-BET switch 45S) has detected press of the BET button by the player, the main CPU 71 makes an addition to a value stored in a number-of-BETs storage area provided in the RAM 73 and makes a subtraction from the value stored in the number-of-credits storage area, based on the type of the BET button (step S46).

The main CPU 71 then determines whether or not the value stored in the number-of-BETs storage area is at its maximum (step S47). When the main CPU 71 determines that the value stored in the number-of-BETs storage area is at its maximum (YES), the main CPU 71 prohibits updating of the value stored in the number-of-BETs storage area (step S48).

After step S48 or when determining in step S47 that the value stored in the number-of-BETs storage area is not at its maximum (NO), the main CPU 71 permits operation acceptance of the SPIN button 46 (step S49).

After step S49 or when determining in step S45 that the operation of any of the BET buttons has not been detected (NO), or when determining in step S43 that the value stored in the number-of-credits storage area is zero (YES), the main CPU 71 determines whether or not operation of the SPIN button 46 has been detected (step S50). When the main CPU 71 determines that the operation of the SPIN button has not been detected (NO), the processing is returned to step S41.

When the main CPU 71 determines that the operation of the SPIN button 46 has been detected (YES), the main CPU 71 exits this subroutine.

### <Symbol Rewrite Processing>

FIG. 15 is a flowchart illustrating a subroutine of symbol rewrite processing. The symbol rewrite processing is invoked in step S14 of the main control processing in FIG. 13.

First, the main CPU 71 extracts a random value for symbol rewrite (step S1511). The main CPU 71 determines whether the extracted random value is a value to conduct symbol rewrite (step S1513). When determining that the extracted random value is not a value to conduct symbol rewrite (NO), or symbol rewrite is not to be conducted, the main CPU 71 immediately exit this subroutine.

When determining that the extracted random value is a value to conduct symbol rewrite (YES), the main CPU 71 determines the symbols to replace (replacement symbols) in accordance with the extracted random value (step S1515). In the present embodiment, one kind of symbols out of JACK, QUEEN, KING, NINE, ACE, TEN, MOUSE, RABBIT, DEER, WOLF, and FEATURE are selected as replacement symbols in step S1515.

It is to be noted that WILD symbols are not selected as the replacement symbols in the present embodiment. If WILD symbols are selected as the replacement symbols, a possibility to pay an excessive dividend to the player is generated. For example, if the WILD symbols are replaced with different kinds of symbols so as to be most advantageous for the player, a possibility to pay an excessive dividend to the player is generated. Specifically, in the case where WILD symbols are rearranged in the entire symbol display region 4, or fifteen WILD symbols are rearranged, all the fifteen WILD symbols are replaced with the kind of symbols for providing the highest dividend and the dividend is paid out. Such a situation might inflict a loss on the game facility such as a casino. Accordingly, the game facility such as a casino eliminates WILD symbols from being selected as the replacement symbols to secure their benefit.

Next, the main CPU 71 determines whether the replacement symbols determined in step S1515 are FEATURE symbols (step S1516). When determining that the replacement symbols determined in step S1515 are FEATURE symbols (YES), the main CPU 71 determines the rewrite start position in accordance with the code number of the to-be stopped symbol for each of the first video reel 3a, the second video reel 3b, the third video reel 3c, the fourth video reel 3d, and the fifth video reel 3e (step S1517).

For example, the code number obtained by subtracting a predetermined value from the code number of the to-be stopped symbol can be defined as the rewrite start position. Hereinafter, determining the rewrite start position is described.

FIG. 22A is a view illustrating symbol arrays before rewriting the symbols and the symbols rearranged in the symbol display region 4 when the first to the fifth video reels 3a to 3e are stopped. In the example shown in FIG. 22A, each rectangle surrounded by a thick line represents the symbol display region 4. The symbols inside the rectangle surrounded by the thick line are the fifteen symbols shown in the symbol display region 4 in the previous unit game. FIG. 22A shows a symbol display region 4 denoted by a reference sign (a) (hereinafter, referred to as symbol display region 4(a)) and a symbol display region 4 denoted by a reference sign (b) (hereinafter, referred to as symbol display region 4(b)). The symbol display region 4(a) indicates that the symbols rearranged in the previous unit game are the symbols of code Nos. 18 to 20. The symbol display region 4(b) indicates that the symbols rearranged in the previous unit game are the symbols of code Nos. 32 to 34. The symbol display region 4(b) will be described later.

First, as to the symbol display region 4(a), the first video reel 3a is stopped to show a FEATURE symbol in the top row, an ACE symbol in the middle row, and a DEER symbol in the bottom row in the previous unit game. The second video reel 3b is stopped to show a WILD symbol in the top row, a QUEEN symbol in the middle row, and a MOUSE symbol in the bottom row. The third video reel 3c is stopped to show a WILD symbol in the top row, a KING symbol in the middle row, and an ACE symbol in the bottom row. The fourth video reel 3d is stopped to show a TEN symbol in the top row, a MOUSE symbol in the middle row, and a JACK symbol in the bottom row. The fifth video reel 3e is stopped to show a NINE symbol in the top row, an ACE symbol in the middle row, and a MOUSE symbol in the bottom row.

As mentioned previously, the to-be stopped symbols are shown in a predetermined region (e.g., the top row) in the symbol display region 4. Accordingly, in the example of the symbol display region 4(a), the to-be stopped symbols in the previous unit game are the FEATURE symbol (code No. 18) for the first video reel 3a, the WILD symbol (code No. 18) for the second video reel 3b, the WILD symbol (code No. 18) for the third video reel 3c, the TEN symbol (code No. 18) for the fourth video reel 3d, and the NINE symbol (code No. 18) for the fifth video reel 3e.

As noticed, in the example of the symbol display region 4(a), the code numbers of the to-be stopped symbols in the previous unit game are all 18. Accordingly, in step S1517, code No. 16, which is obtained by subtracting a predetermined value of 2 from code No. 18 of the to-be stopped symbols in the previous unit game, is determined to be the rewrite start position. Although the code numbers of the to-be stopped symbols are all the same in the example illustrated in FIG. 22A, the code numbers of the to-be stopped symbols may be different in each unit game.

FIG. 22B is a view illustrating symbol arrays after the same symbols as those in FIG. 22A are rearranged in the symbol display region 4(a) and then the symbols are rewritten assuming that the rewrite start position is code No. 16 which is obtained by subtracting 2 from code No. 18.

As shown in FIG. 22B, the symbols of the code numbers not more than 14 are replaced by FEATURE symbols of the replacement symbols. Although the rewrite start position is code No. 16, the symbols of code Nos. 15 and 16 cannot be replaced by FEATURE symbols and the original symbols are maintained because, as shown in FIG. 22A, the symbols of code Nos. 15 and 16 are not BOX symbols. The number of symbols to be replaced is described with step S1519.

This embodiment does not determine code No. 17, which is adjacent to code No. 18 of the to-be stopped symbol in the previous unit game, to be the rewrite start position, as shown in FIG. 22B. Because of bound effect in rearranging symbols in the symbol display region 4 in the previous unit game, at least a part of the symbols of code No. 17 might be seen by the player. Accordingly, if the symbols of code No. 17 are replaced, the player may feel strange because the symbols are different from the ones seen by the player. For this reason, the present embodiment does not treat the symbols of code No. 17 as the objects of rewrite.

In the present embodiment, the bound effect is a kind of effect to show, in stopping scrolling of the first video reel 3a, the second video reel 3b, the third video reel 3c, the fourth video reel 3d, and the fifth video reel 3e, the symbol arrays in such a motion that they repeatedly bound along the scrolling direction (move back and forth) while gradually decreasing the amplitude of the motion.

Considering the bound effect in rearranging the symbols, the present embodiment hence determines the start position to rewrite the symbols so that each symbol array will include at least one symbol not to be rewritten between the top row of the symbol display region 4 and the start position to rewrite the symbols.

The present embodiment treats the symbols of code No. 16, which is the second number from code No. 18 of the to-be stopped symbol in the previous unit game, and the symbols of code numbers smaller than 16 as the objects of rewrite. However, as described above, the symbols of code Nos. 15 and 16 cannot be replaced with FEATURE symbols since they are not BOX symbols; the symbols of code numbers not more than 14 are replaced with FEATURE symbols. Hence, in the ongoing unit game, the FEATURE symbols of code No. 14 appear in the symbol display region 4 after the symbol arrays have scrolled down by four rows of symbols since the start of scrolling. That is to say, the FEATURE symbols of code No. 14 do not appear in the symbol display region 4 immediately after the start of scrolling but appear after four rows of symbols of code Nos. 18, 17, 16, and 15 have moved.

In the case of FIG. 22D in which the rewrite start position is code No. 14, the FEATURE symbols of code No. 14 appear in the symbol display region 4 when the symbol arrays have scrolled down by two rows of symbols since the start of scrolling. In the case of FIG. 22C in which the rewrite start position is code No. 15, the FEATURE symbols of code No. 14 appear in the symbol display region 4 after the symbol arrays have scrolled down by three rows of symbols since the start of scrolling, which is later than in the case of FIG. 22D. In the case of FIG. 22B in which the rewrite start position is code No. 16, the FEATURE symbols of code No. 14 appear in the symbol display region 4 after the symbol arrays have scrolled down by four rows of symbols since the start of scrolling, which is more later than in the case of FIG. 22C. In this way, the closer the rewrite start position to the BOX symbols of code No. 14, the sooner the FEATURE symbols appear in the symbol display region 4.

In the example shown in FIG. 22B, the main CPU 71 subtracts a fixed value 2 of a predetermined value from the code number of the to-be stopped symbol to determine the start position; however, the predetermined value to be subtracted is not limited to a fixed value. For example, the main CPU 71 randomly determines one value from a certain range, for example a range from 2 to 4, and subtracts the value as the predetermined value.

FIG. 22C is a view illustrating symbol arrays after the same symbols as those in FIG. 22A are rearranged in the symbol display region 4(a) and then the symbols are rewritten assuming that the rewrite start position is code No. 15, which is obtained by subtracting a predetermined value of 3 from code No. 18. Like in the case of FIG. 22B, the symbols of code numbers not more than 14 are replaced with replacement FEATURE symbols. Although the rewrite start position is code No. 15, the symbols of code No. 15 are not rewritten with FEATURE symbols and the original symbols are maintained since they are not BOX symbols.

As shown in FIG. 22A, two rows of symbols of code Nos. 16 and 17 are present along the scrolling direction between code Nos. 18 and 15 before the rewrite. After the rewrite, however, as shown in FIG. 22C, the symbols of code No. 16 have been deleted and only one row of symbols of code No. 17 are present between code Nos. 18 and 15. In this way, between the top row of the symbol display region 4 and the rewrite position, two rows of symbols are placed before the rewrite and only one row of symbols are placed after the rewrite.

To delete the symbols of code No. 16, the main CPU 71 needs to delete the data in the storage area corresponding to code No. 16 from the symbol table defining the symbol arrays in the RAM 73.

This deletion of code No. 16 can expedite the appearance of the FEATURE symbols of code No. 14 in the symbol display region 4 since start of scrolling. That is to say, in the case of FIG. 22C where the rewrite start position is code No. 15, the FEATURE symbols of code No. 14 appear in the symbol display region 4 when the symbol arrays have scrolled down by three rows of symbols since the start of scrolling.

As noted from the above, in both views of the bound effect in rearranging symbols and sooner appearance of FEATURE symbols in the ongoing unit game, it is desirable that at least one row of symbols be placed between the top row of the symbol display region 4 and the rewrite position along the direction of scrolling.

FIG. 22D is a view illustrating symbol arrays after the same symbols as those in FIG. 22A are rearranged in the symbol display region 4(a) and then the symbols are rewritten assuming that the rewrite start position is code No. 14, which is obtained by subtracting a predetermined value of 4 from code No. 18. Like in the cases of FIGS. 22B and 22C, the symbols of code numbers not more than 14 are replaced with replacement FEATURE symbols as shown in FIG. 22D.

As shown in FIG. 22A, three rows of symbols of code Nos. 15, 16, and 17 are present along the scrolling direction between code Nos. 18 and 14 before the rewrite. After the rewrite, however, as shown in FIG. 22D, the symbols of code Nos. 15 and 16 have been deleted and only one row of symbols of code No. 17 are present between code Nos. 18 and 14. In this way, between the top row of the symbol display region 4 and the rewrite position, three rows of symbols are placed before rewrite and only one row of symbols are placed after rewrite.

To delete the symbols of code Nos. 15 and 16, the main CPU 71 needs to delete the data in the storage area corresponding to code Nos. 15 and 16 from the symbol table defining the symbol arrays in the RAM 73.

This deletion of code Nos. 15 and 16 can expedite the appearance of the FEATURE symbols of code No. 14 in the symbol display region 4 since the start of scrolling. That is to say, in the case of FIG. 22D where the rewrite start position is code No. 14, the FEATURE symbols of code No. 14 appear in the symbol display region 4 when the symbol arrays have scrolled down by two rows of symbols since the start of scrolling.

In this case, too, in both views of the bound effect in rearranging symbols and sooner appearance of FEATURE symbols in the ongoing unit game, it is desirable that at least one row of symbols be placed between the top row of the symbol display region 4 and the rewrite position along the direction of scrolling.

The foregoing examples have described cases where the symbols of code Nos. 18 to 20 are rearranged in the previous unit game (symbol display region 4(a)). Hereinafter, some cases where the symbols of code Nos. 32 to 34 are rearranged in the previous unit game (symbol display region 4(b)) are described.

As to the symbol display region 4(b), the first video reel 3a is stopped to show a FEATURE symbol in the top row, a TEN symbol in the middle row, and a KING symbol in the bottom row in the previous unit game. The second video reel 3b is stopped to show a WOLF symbol in the top row, an ACE symbol in the middle row, and a MOUSE symbol in the bottom row. The third video reel 3c is stopped to show an ACE symbol in the top row, a FEATURE symbol in the middle row, and a TEN symbol in the bottom row. The fourth video reel 3d is stopped to show a WILD symbol in the top row, a TEN symbol in the middle row, and a RABBIT symbol in the bottom row. The fifth video reel 3e is stopped to show a NINE symbol in the top row, a WOLF symbol in the middle row, and a QUEEN symbol in the bottom row.

As mentioned previously, the to-be stopped symbols are shown in a predetermined region (e.g., the top row) in the symbol display region 4. Accordingly, in the example of the symbol display region 4(b), the to-be stopped symbols in the previous unit game are the FEATURE symbol (code No. 32) for the first video reel 3a, the WOLF symbol (code No. 32) for the second video reel 3b, the ACE symbol (code No. 32) for the third video reel 3c, the WILD symbol (code No. 32) for the fourth video reel 3d, and the NINE symbol (code No. 32) for the fifth video reel 3e.

As noticed, in the example of the symbol display region 4(b), the code numbers of the to-be stopped symbols in the previous unit game are all 32. Accordingly, in step S1517, code No. 16, which is obtained by subtracting a predetermined value of 16 from code No. 32 of the to-be stopped symbol in the previous unit game, is determined to be the rewrite start position. Although the code numbers of the to-be stopped symbols are all the same in the example illustrated in FIG. 22A, the code numbers of the to-be stopped symbols may be different in each unit game.

FIG. 22E is a view illustrating symbol arrays after the same symbols as those in FIG. 22A are rearranged in the symbol display region 4(b) and then the symbols are rewritten assuming that the rewrite start position is code No. 16, which is obtained by subtracting a predetermined value of 16 from code No. 32. Like in the case of FIG. 22B, the symbols of the code numbers not more than 14 are replaced with FEATURE symbols of the replacement symbols. Although the rewrite start position is code No. 16, the symbols of code Nos. 15 and 16 are not rewritten with FEATURE symbols and the original symbols are maintained since they are not BOX symbols.

FIG. 22F is a view illustrating symbol arrays after the same symbols as those in FIG. 22A are rearranged in the symbol display region 4(b) and then the symbols are rewritten assuming that the rewrite start position is code No. 15, which is obtained by subtracting a predetermined value of 17 from code No. 32. Like in the case of FIG. 22C, the symbols of the code numbers not more than 14 are replaced with FEATURE symbols of the replacement symbols. Although the rewrite start position is code No. 15, the symbols of code No. 15 are not rewritten with FEATURE symbols and the original symbols are maintained since they are not BOX symbols.

FIG. 22G is a view illustrating symbol arrays after the same symbols as those in FIG. 22A are rearranged in the symbol display region 4(b) and then the symbols are rewritten assuming that the rewrite start position is code No. 14, which is obtained by subtracting a predetermined value of 18 from code No. 32. Like in the case of FIG. 22D, the symbols of the code numbers not more than 14 are replaced with FEATURE symbols of the replacement symbols.

In the examples of the symbol display region 4(b), too, in both views of the bound effect in rearranging symbols in the previous unit game and sooner appearance of FEATURE symbols in the ongoing unit game, it is desirable that at least one row of symbols (the symbols of code No. 31) be placed between the top row of the symbol display region 4 and the rewrite position along the direction of scrolling.

As described above, in the case where the replacement symbols are FEATURE symbols, the rewrite start position is determined depending on the code number of the to-be stopped symbol and the symbols are rewritten with FEATURE symbols.

The foregoing examples determine one of 2 to 4 for a predetermined value to be subtracted in the cases of the symbol display region 4(a) in FIG. 22A and one of 16 to 18 in the cases of the symbol display region 4(b) in FIG. 22A. Although the foregoing examples determine the rewrite start position by determining the predetermined value to be subtracted, the rewrite start position may be directly designated with a code number. That is to say, one of the code numbers 14 to 16 may be directly designated to determine the rewrite start position. In either case, the rewrite start position should be determined to satisfy the both requirements about the bound effect in rearranging symbols in the previous unit game and the sooner appearance of FEATURE symbols in the ongoing unit game.

Selection of the rewrite start position from the code Nos. 14, 15, and 16 may be determined randomly by lottery. Alternatively, the rewrite start position may be predetermined at a fixed code number, for example code No. 14.

As described above, the rewrite start position can be selected from a plurality of positions. Particularly, it is preferable that the rewrite start position be selected from a plurality of positions in accordance with the kinds of symbols determined by lottery in step S15 in FIG. 13 or step S1819 in FIG. 18. For example, if the symbols determined by lottery are not FEATURE symbols, it is desirable to determine the rewrite start position by selecting one position from a plurality of positions so that the symbols determined by lottery are not replaced by FEATURE symbols. As a result, the symbols determined by lottery can appear in the symbol display region 4 in rearrangement.

When determining in step S1516 that the replacement symbols determined in step S1515 are not FEATURE symbols (NO), the main CPU 71 determines a predetermined position to be the rewrite position (step S1518). That is to say, unless the replacement symbols are FEATURE symbols, the main CPU 71 determines the predetermined position to be the rewrite position regardless of the to-be stopped symbol in the previous unit game. For example, it always determines code No. 14 shown in FIG. 7 to be the rewrite position. Accordingly, unless the replacement symbols are FEATURE symbols, the rewrite position is determined independently from the stop position in the previous unit game, for each of the first video reel 3a to the fifth video reel 3e.

In contrast, if the replacement symbols are FEATURE symbols, the main CPU 71 determines the rewrite start position depending on the to-be stopped symbol (code number) in the previous unit game as described in step S1517.

Although the foregoing example has described that a fixed position is determined to be the rewrite position unless the replacement symbols are FEATURE symbols, required is not to determine the rewrite position depending on the to-be stopped symbol in the previous game. The rewrite position may be determined at random with a random number. Alternatively, it may be determined depending on the kinds of symbols determined by lottery in step S15 of FIG. 13 or step S1819 of FIG. 18.

Furthermore, the five video reels of the first video reel 3a to the fifth video reel 3e may include reels to be rewritten and reels not to be rewritten together. In the case of coexistence of reels to be rewritten and reels not to be rewritten, whether to rewrite can be determined depending on the kinds of symbols determined by lotteries in in step S15 of FIG. 13 or step S1819 of FIG. 18. The combination of the reels to be rewritten and not to be rewritten can be a hint of the symbols determined by lotteries for the player. For example, in the case where symbols to provide a small dividend have been drawn, the number of reels to be rewritten may be configured to be smaller and in the case where symbols to provide a big dividend have been drawn, the number of reels to be rewritten may be configured to be greater. As a result, the player can know whether the dividend is big or small through the combination of the reels to be rewritten and not to be rewritten.

After executing step S1517 or S1518, the main CPU 71 determines the number of symbols to be replaced (step S1519). Step S1519 determines the number of symbols to be replaced for each of the first video reel 3a, the second video reel 3b, the third video reel 3c, the fourth video reel 3d, and the fifth video reel 3e. For example, the main CPU 71 generates a random number to determine the number of symbols to be replaced in accordance with the value of the random number.

In the example of FIG. 22A, seven symbols are replaced on the first video reel 3a; eight symbols are replaced on the second video reel 3b; seven symbols are replaced on the third video reel 3c; nine symbols are replaced on the fourth video reel 3d; and nine symbols are replaced on the fifth video reel 3e.

The numbers of symbols to be replaced may be fixed. Furthermore, the same number of symbols may be replaced on all of the first video reel 3a to the fifth video reel 3e.

After execution of step S1519, the main CPU 71 replaces the symbols in the number determined in step S1519 from the start position determined in step S1517 with the symbols selected in step S1515 (step S1521) and exits this subroutine.

In the example illustrated in FIG. 22A, all the cells indicated with BOX are rewritten with the one kind of symbols selected in step S1515.

### <Symbol Display Control Processing>

FIG. 16 is a flowchart illustrating a subroutine of symbol display control processing. The symbol display control processing is invoked in step S17 in the main control processing of FIG. 13.

First, the main CPU 71 determines whether the symbols have been rewritten (step S1611). This determination is the same as step S1513 in FIG. 15.

When determining in step S1611 that the symbols have been rewritten (YES), the main CPU 71 determines whether the replacement symbols are FEATURE symbols (step S1613).

When determining in step S1611 that the symbols have not been rewritten (NO) or when determining in step S1613 that the replacement symbols are not FEATURE symbols (NO), the main CPU 71 determines the scrolling speed for the first video reel 3a to the fifth video reel 3e at a first scrolling speed (step S1615). The first scrolling speed is a scrolling speed that is normally used.

When determining in step S1613 that the replacement symbols are FEATURE symbols (YES), the main CPU 71 determines the scrolling speed for the first video reel 3a to the fifth video reel 3e at a second scrolling speed (step S1617). The second scrolling speed is a scrolling speed slower than the first scrolling speed.

After execution of step S1615 or step S1617, the main CPU 71 starts scrolling the first video reel 3a to the fifth video reel 3e (step S1619). In the case where the first scrolling speed has been determined in step S1615, the first video reel 3a to the fifth video reel 3e are scrolled at the first scrolling speed. In the case where the second scrolling speed has been determined in step S1617, the first video reel 3a to the fifth video reel 3e are scrolled at the second scrolling speed.

As noted, when the symbols are rewritten into FEATURE symbols, the first video reel 3a to the fifth video reel 3e are scrolled at the second scrolling speed which is slower than the first scrolling speed. Accordingly, since the plurality of FEATURE symbols that have replaced are scrolled slowly, the replacement by the FEATURE symbols can be showy so that the player can clearly recognize it. Since the number of rearranged FEATURE symbols determines the number of unit games in the free game mode, the replacement by FEATURE symbols can provide the player with expectation for more unit games in the free game mode.

Next, the main CPU 71 determines whether the first video reel 3a to the fifth video reel 3e have spun for a predetermined number of rotations since the start of scrolling (step S1621). When determining that they have not spun for the predetermined number of rotations (NO), the main CPU 71 returns to step S1621.

When determining that they have spun for the predetermined number of rotations (YES), the main CPU 71 determines whether the scrolling speed is the second scrolling speed (step S1623). When determining that the scrolling speed is the second scrolling speed (YES), the main CPU 71 determines the scrolling speed at the first scrolling speed (step S1625).

In the case of rewrite with FEATURE symbols, the main CPU 71 scrolls the symbols slowly (the second scrolling speed) in the beginning of the scrolling and after elapse of some time, scrolls the symbols at the normal first scrolling speed. Scrolling at the second scrolling speed enables the FEATURE symbols to be seen by the player, so that the player can clearly recognize the existence of the FEATURE symbols.

Scrolling at the normal first scrolling speed after the scrolling at the second scrolling speed can prevent elongation of the time taken by a unit game, preventing reduction in game media consumption.

Next, the main CPU 71 stops scrolling the symbols based on the symbol storage area storing the to-be stopped symbols (step S1627).

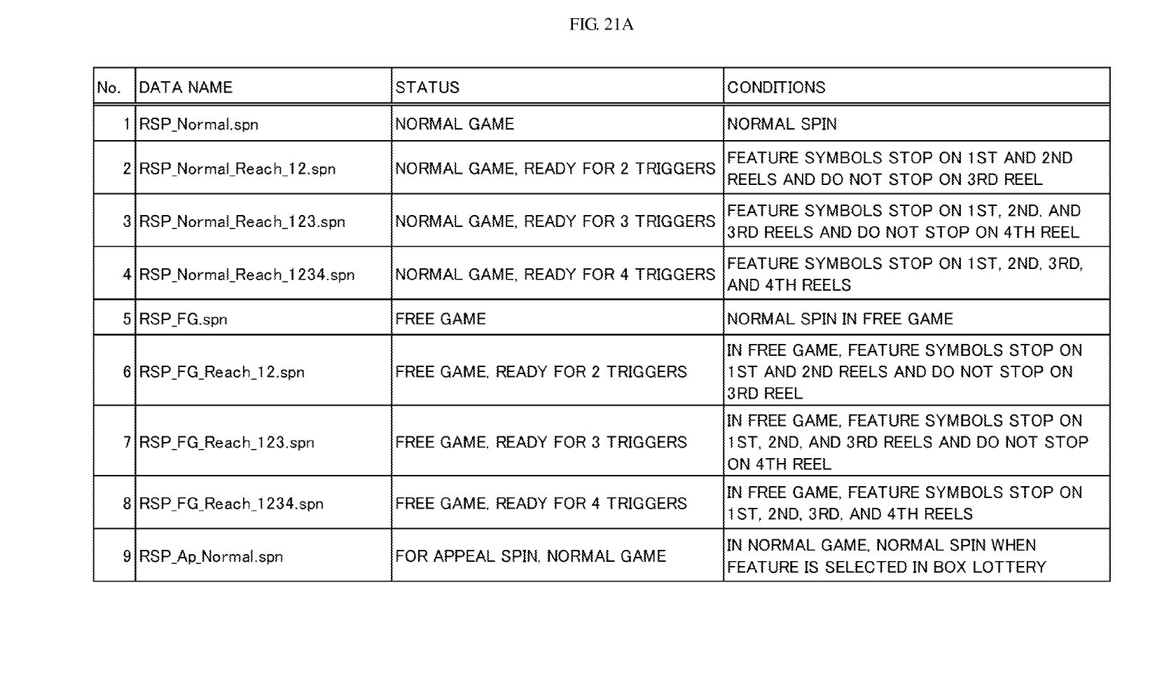

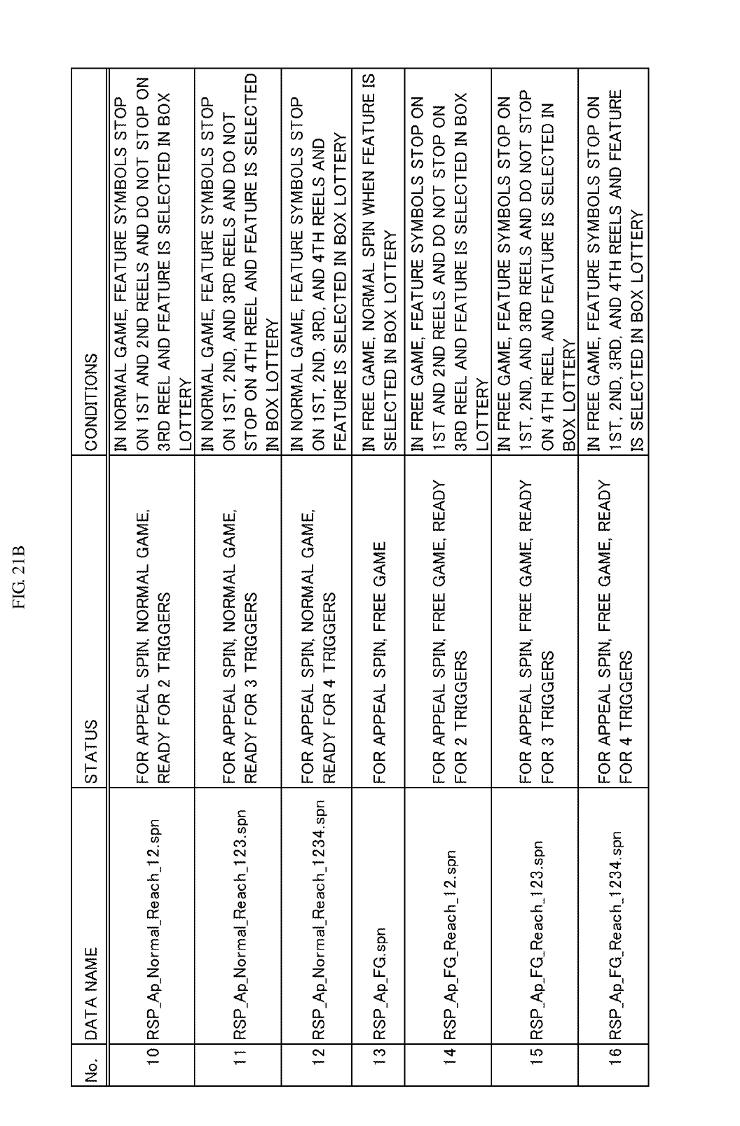

In this step S1627, the main CPU 71 determines the manner to stop the scrolling with reference to the tables shown in FIGS. 21A and 21B. The “appeal spin” in the tables of FIGS. 21A and 21B means scrolling at the second scrolling speed. The “BOX lottery” in the tables of FIGS. 21A and 21B means the symbol rewrite processing.

The example shown in FIGS. 21A and 21B defines data sets numbered 1 to 16. The data sets numbered 1 to 8 are to determine the ways to stop the scrolling in the case where the FEATURE symbols are not selected in the symbol rewrite processing. The data sets numbered 9 to 16 are to determine the ways to stop the scrolling in the case where the FEATURE symbols are selected in the symbol rewrite processing. With reference to these data sets, the main CPU 71 can determine and control the motions of the five video reels 3a to 3e until they finally stop scrolling.

Even in the case where the scrolling is started at the second scrolling speed, the scrolling time from the start to the stop of scrolling may be configured to be the same as in the case where the scrolling is started at the first scrolling speed. Such a configuration can prevent elongation of the time taken by a unit game even in the case where the scrolling is started at the second scrolling speed. In either case where the scrolling is started at the first scrolling speed or at the second scrolling speed, each unit game takes substantially the same time so that the number of times of betting per unit time, for example one hour, can be uniform, preventing reduction in consumption of game media, such as medals.

The foregoing example has described a case where the main CPU 71 determines the scrolling speed at the first scrolling speed or the second scrolling speed depending on the result of selection of FEATURE symbols. Not to be limited to this example, other scrolling speeds such as the third scrolling speed may be defined depending on the selected kind of symbol or the symbols to be rearranged. The scrolling speed can inform the player of the likelihood of rearrangement of the selected symbols or the symbols to be rearranged, enhancing the player's expectation.

Not only a slower speed, the symbols may be scrolled at a faster speed depending on the rearranged symbols. If no dividend is to be paid out, the unit game can be finished sooner to start the next unit game, increasing game media consumption.

### <Bonus Game Processing>

FIG. 17 is a flowchart illustrating a subroutine of bonus game processing. The bonus game processing is invoked in step S20 in the main control processing in FIG. 13 under a condition that a bonus game trigger is established.

First, the main CPU 71 displays a screen illustrating the specifics of bonus games on the lower image display panel 141 (step S1711). The illustration of bonus games urges the player to press the SPIN button 46.

Upon press of the SPIN button 46, the main CPU 71 counts the FEATURE symbols (Step S1713). This counting the FEATURE symbols counts the FEATURE symbols rearranged in the symbol display region 4 when the bonus game trigger is established (step S19 in FIG. 13).

Through this step, the number of FEATURE symbols is obtained from 3 to 15. The obtained number of FEATURE symbols is stored in the RAM 73.

Next, the main CPU 71 determines whether the number of FEATURE symbols obtained in step S1713 is 15 (step S1715). If the number of FEATURE symbols is 15 (YES), the number of special additional unit games (special additional free games), for example 50, is determined (step S1717).

After executing step S1717 or when determining in S1715 that the number of FEATURE symbols is not 15 (NO), the main CPU 71 performs number-of-free-games determination processing (step S1719). In step S1719, the main CPU 71 determines the number of free games with reference to the number-of-free-games determination lottery table shown in FIG. 11.

Specifically, if the result of step S1713 indicates that the number of FEATURE symbols is one of 3 to 5, the main CPU 71 refers to the “Very_Low” column in the number-of-free-games determination lottery table shown in FIG. 11. If the result of step S1713 indicates that the number of FEATURE symbols is one of 6 to 8, the main CPU 71 refers to the “Low” column in the number-of-free-games determination lottery table shown in FIG. 11. If the result of step S1713 indicates that the number of FEATURE symbols is 9 or 10, the main CPU 71 refers to the “Middle” column in the number-of-free-games determination lottery table shown in FIG. 11. If the result of step S1713 indicates that the number of FEATURE symbols is 11 or 12, the main CPU 71 refers to the “High” column in the number-of-free-games determination lottery table shown in FIG. 11. If the result of step S1713 indicates that the number of FEATURE symbols is 13 or 14, the main CPU 71 refers to the “Very_High” column in the number-of-free-games determination lottery table shown in FIG. 11. If the result of step S1713 indicates that the number of FEATURE symbols is 15, the main CPU 71 refers to the “EXTRA” column in the number-of-free-games determination lottery table shown in FIG. 11.

Next, the main CPU 71 displays the number of free games (step S1721). This processing in step S1721 displays the number of free games determined in step S1719.

Next, the main CPU 71 updates the number of FEATURE symbols stored in the RAM 73 after subtracting 1 therefrom (step S1723).

Next, the main CPU 71 determines whether the number of FEATURE symbols updated in step S1723 is greater than 0 (step S1725).

When determining in step S1725 that the number of FEATURE symbols is greater than 0 (YES), the main CPU 71 returns to step S1719. Hence, determination of the number of free games in step S1719 is repeated in accordance with the number of FEATURE symbols rearranged in the symbol display region 4 at the establishment of a bonus game trigger (step S19 in FIG. 13). As the number of FEATURE symbols is greater, the number of free games can be determined more times.

Next, the main CPU 71 calculates the total number of free games and displays it (step S1727). The total number of free games is the total sum of the numbers of free games determined as results of determinations of the number of free games in step S1719. If the special additional free games are provided in step S1717, the number of special additional free games is also added.

Subsequently, the main CPU 71 displays an image indicating a free game choice button and an image indicating a roulette game choice button on the lower image display panel 14 (step S1729). It further displays a message urging the player to choose either the free game choice button or the roulette game choice button on the lower image display panel 141.

It is to be noted that, when displaying the free game choice button and the roulette game choice button on the lower image display panel 141, the main CPU 71 may inform the player of an estimated end time of the free games in the case where the determined number of free games are conducted. For example, the main CPU 71 multiplies a time required to conduct a free game (such as an average time calculated in advance) by the determined number of free games and shows the result.

Next, the main CPU 71 determines whether the player's choice is the free game choice button (step S1731). If the player's choice is the free game choice button (YES), the main CPU 71 invokes and executes the subroutine of free game execution processing illustrated in later-described FIG. 18 (step S1733).

When determining in step S1731 that the player's choice is not the free game choice button (NO), the main CPU 71 invokes and executes the subroutine of roulette game execution processing illustrated in later-described FIG. 20 (step S1735).

After step S1733 or S1735, the main CPU 71 exits this subroutine.

It is to be noted that the free game choice button and the roulette game choice button may be displayed on the lower image display panel 141 only in the case where the number of free games to be provided is a predetermined number, for example 100, or more. As a result, the choice of roulette game is available only when the time of the free game mode is extremely long and the game mode is quickly returned to the base games if the roulette game is chosen. The expedited game progression can increase the consumption of game media consumption.

### <Free Game Execution Processing>

FIG. 18 is a flowchart illustrating a subroutine of free game execution processing. The free game execution processing is invoked and executed in step S1735 in FIG. 17. A free game in the present embodiment conducts a slot game (unit game) like a base game. The free game can start a slot game (unit game) without bet.

First, the main CPU 71 displays the number of free games acquired in bonus game processing in FIG. 17 (step S1811). The number of remaining free games is stored in the RAM 73.

Next, the main CPU 71 conducts at-one-game-end initialization processing (step S1813). For example, data that becomes unnecessary after each game in the working areas of the RAM 73, such as the symbols determined by lottery, is cleared.

The main CPU 71 then determines whether the SPIN button 46 has been operated (step S1815). When determining that the SPIN button 46 has not been operated (NO), the main CPU 71 returns to step S1815.

When determining in step S1815 that the SPIN button 46 has been operated (YES), the main CPU 71 invokes and executes symbol lottery processing (step S1819). In this processing, to-be stopped symbols are determined based on random values for symbol determination.

Specifically, the main CPU 71 extracts five random values of the first to fifth random values for symbol determination. Next, the main CPU 71 determines a to-be stopped symbol for the first video reel 3a with the first random value, a to-be stopped symbol for the second video reel 3b with the second random value, a to-be stopped symbol for the third video reel 3c with the third random value, a to-be stopped symbol for the fourth video reel 3d with the fourth random value, and a to-be stopped symbol for the fifth video reel 3e with the fifth random value. The determined to-be stopped symbols for the first to the fifth video reels 3a to 3e are stored in a symbol storage area provided in the RAM 73.

Next, the main CPU 71 invokes and executes the subroutine of symbol rewrite processing illustrated in FIG. 15 (step S1817). This symbol rewrite processing is the same as the processing executed in S14 of the main control processing illustrated in FIG. 13. The lottery table for the symbol rewrite may be defined differently from the one referred to in the main control processing.

Next, the main CPU 71 conducts effect contents determination processing (step S1821). The main CPU 71 extracts a random value for effect, and determines any one of the effect contents from the preset plurality of effect contents by lottery.

The main CPU 71 then invokes and conducts the subroutine of symbol display control processing illustrated in FIG. 16 (step S1823). In this processing, scrolling of the symbol arrays formed of the symbols placed on the first video reel 3a, the second video reel 3b, the third video reel 3c, the fourth video reel 3d, and the fifth video reel 3e is started. After a predetermined time has elapsed since the start of scrolling, the scrolling is stopped. The scrolling is stopped in such a manner that the to-be stopped symbols determined in the symbol lottery processing of step S1819 are stopped at predetermined positions (e.g. the top row in the symbol display region 4). That is, fifteen symbols including the to-be stopped symbols are displayed in the symbol display region 4. In this way, rearrangement of symbols is performed.

Next, the main CPU 71 conducts number-of-payouts determination processing (step S1825). This processing determines the number of payouts based on the symbols rearranged along valid paylines 300 with reference to the payout determination table (FIG. 10) stored in the ROM 72. The determined number of payouts is stored into a number-of-payouts storage area provided in the RAM 73.

The main CPU 71 then determines whether a retrigger has been established (step S1827). The retrigger in the present embodiment is a rearranged symbols including at least one FEATURE symbol on each of the first video reel 3a, the second video reel 3b, and the third video reel 3c. That is to say, the requirement of establishment of a retrigger is the same as that of the bonus game trigger for entering bonus games.

Accordingly, even if three FEATURE symbols are rearranged on the first video reel 3a and three FEATURE symbols are rearranged on the second video reel 3b, the retrigger is not established unless at least one FEATURE symbol is rearranged on the third video reel 3c.

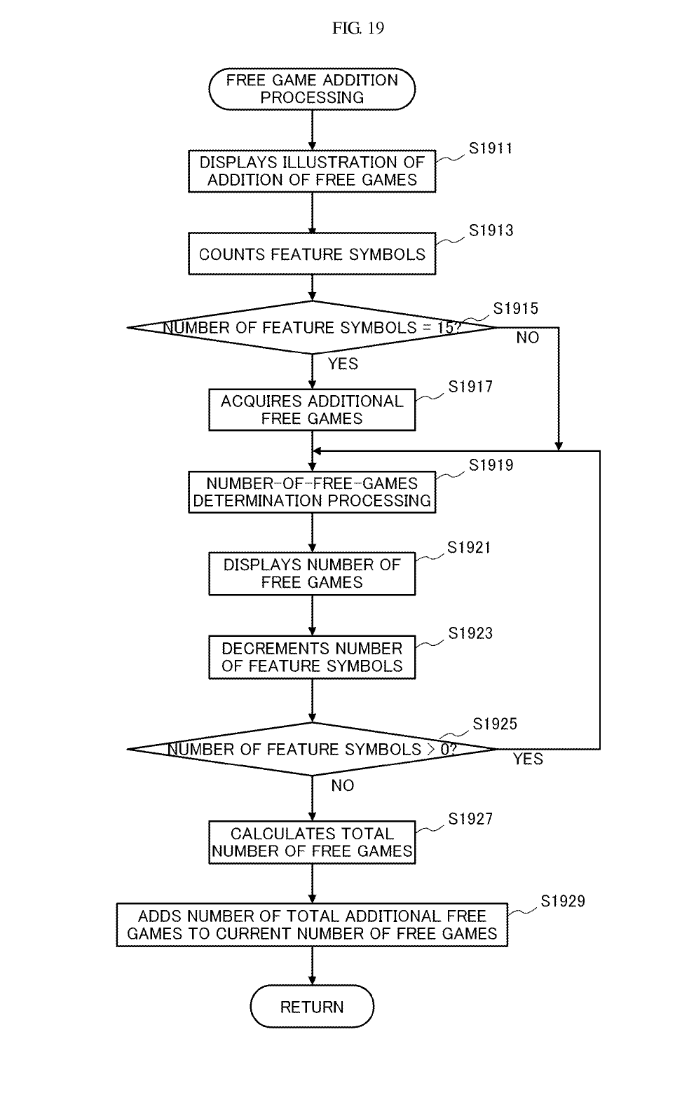

When determining in step S1827 that a retrigger has been established (YES), the main CPU 71 invokes and conducts a subroutine of free game addition processing illustrated in FIG. 19 (step S1829).

After executing step S1829 or when determining in step S1827 that a retrigger has not been established (NO), the main CPU 71 determines whether any dividend is to be provided (step S1831). This is to determine whether a dividend is to be provided in accordance with the forgoing number-of-payouts determination processing in step S1825.

When determining that a dividend is to be provided in the determination of step S1831 (YES), the main CPU 71 conducts multiplying factor lottery processing to determine a multiplying factor for the dividend by lottery (step S1833). In this multiplying factor lottery processing, the main CPU 71 determines a multiplying factor for the dividend by lottery, out of ×2, ×3, ×4, and ×5. The determined multiplying factor is indicated in the multiplying factor display window.

Next, the main CPU 71 conducts payout processing (step S1835). In this payout processing, the main CPU 71 pays out a value obtained by multiplying the dividend determined in step S1825 by the multiplying factor determined in step S1833 as a final dividend. For example, in the case where the dividend determined in step S1825 is 100 credits and the multiplying factor determined in step S1833 is ×5, 500 credits (100×5=500) are paid out as the final dividend.

After executing step S1835 or when determining in S1831 that no dividend is to be provided (NO), the main CPU 71 updates the number of remaining free games stored in the RAM 73 with the number obtained by subtracting 1 from the number of remaining free games stored in the RAM 73 (step S1837). For example, in the case where the number of remaining free games stored in the RAM 73 is 12, the number of remaining free games is updated with the value of 11 obtained by subtracting 1 from 12.

Next, the main CPU 71 determines whether the number of remaining free games updated in step S1837 is greater than 0 (step S1839). When determining that the number of remaining free games is greater than 0 (YES), the main CPU 71 returns to step S1811.

When determining that the number of remaining free games is 0 (NO), the main CPU 71 exits this subroutine.

### <Free Game Addition Processing>

FIG. 19 is a flowchart illustrating a subroutine of free game addition processing. The free game addition processing is invoked and executed in step S1829 in FIG. 18.

First, the main CPU 71 displays a screen illustrating the specifics of addition of free games on the lower image display panel 141 (step S1911). The illustration of addition of free games urges the player to press the SPIN button 46.

Upon press of the SPIN button 46, the main CPU 71 counts the FEATURE symbols (step S1913). This step of counting the FEATURE symbols counts the FEATURE symbols rearranged in the symbol display region 4 when a retrigger is established (step S1827 in FIG. 18).

Through this step, the number of FEATURE symbols is obtained out of three to fifteen. The obtained number of FEATURE symbols is stored in the RAM 73.

Next, the main CPU 71 determines whether the number of FEATURE symbols obtained in step S1913 is 15 (step S1915). If the number of FEATURE symbols is 15 (YES), the number of special additional unit games (special additional free games), for example 50, is determined (step S1917).

After executing step S1917 or when determining in S1915 that the number of FEATURE symbols is not 15 (NO), the main CPU 71 performs number-of-free-games determination processing (step S1919). In step S1919, the main CPU 71 determines the number of free games with reference to the number-of-free-games determination lottery table shown in FIG. 11.

Specifically, if the result of step S1913 indicates that the number of FEATURE symbols is one of 3 to 5, the main CPU 71 refers to the “Very_Low” column in the number-of-free-games determination lottery table shown in FIG. 11. If the result of step S1913 indicates that the number of FEATURE symbols is one of 6 to 8, the main CPU 71 refers to the “Low” column in the number-of-free-games determination lottery table shown in FIG. 11. If the result of step S1913 indicates that the number of FEATURE symbols is 9 or 10, the main CPU 71 refers to the “Middle” column in the number-of-free-games determination lottery table shown in FIG. 11. If the result of step S1913 indicates that the number of FEATURE symbols is 11 or 12, the main CPU 71 refers to the “High” column in the number-of-free-games determination lottery table shown in FIG. 11. If the result of step S1913 indicates that the number of FEATURE symbols is 13 or 14, the main CPU 71 refers to the “Very_High” column in the number-of-free-games determination lottery table shown in FIG. 11. If the result of step S1913 indicates that the number of FEATURE symbols is 15, the main CPU 71 refers to the “EXTRA” column in the number-of-free-games determination lottery table shown in FIG. 11.

Next, the main CPU 71 displays the number of free games (step S1921). This processing in step S1921 displays the number of free games determined in step S1919.

Next, the main CPU 71 updates the number of FEATURE symbols stored in the RAM 73 after subtracting 1 therefrom (step S1923).

Next, the main CPU 71 determines whether the number of FEATURE symbols updated in step S1923 is greater than 0 (step S1925).

When determining in step S1925 that the number of FEATURE symbols is greater than 0 (YES), the main CPU 71 returns to step S1919. As a result, depending on the number of FEATURE symbols rearranged in the symbol display region 4 at the establishment of a retrigger (step S1827 in FIG. 18), the number-of-free-games determination processing in step S1919 is repeated. Accordingly, as the number of FEATURE symbols is greater, the number-of-free-games determination processing is executed more times.

Next, the main CPU 71 calculates the total number of additional free games and displays it (step S1927). The total number of free games is the total sum of the numbers of free games determined in the number-of-free games determination processing in step S1919. If special additional free games are provided in step S1917, the number of special additional free games is also added.

Next, the main CPU 71 adds the number of total additional free games to the current number of free games (step S1929) and exits this subroutine. Through this subroutine, free games can be added when a retrigger is established.

### <Roulette Game Execution Processing>

FIG. 20 is a flowchart illustrating a subroutine of roulette game execution processing. The roulette game execution processing is invoked and executed in step S1737 in FIG. 17. Although the roulette game in the present embodiment is conducted as a one-time game, it may be a game that can determine an award with lotteries fewer than the number of free games, for example, one lottery.

First, the main CPU 71 displays a screen illustrating the specifics of the roulette game on the lower image display panel 141 (step S2011).

Next, the main CPU 71 displays eight targets 201A to 201H disposed to look like a wheel on the lower image display panel 141 as shown in FIG. 2 (step S2013). Each of the targets 201A to 201H indicates a dividend in credit. In the present embodiment, the target 201A indicates 10 credits; the target 201B indicates 80 credits; the target 201C indicates 20 credits; the target 201D indicates 90 credits; the target 201E indicates 30 credits; the target 201F indicates 70 credits; the target 201G indicates 40 credits; and the target 201H indicates 60 credits. In step S2013, the main CPU 71 also displays a message urging the player to press the SPIN button 46.

Next, the main CPU 71 determines whether the SPIN button 46 has been operated (step S2015). When determining that the SPIN button 46 has not been operated (NO), the main CPU 71 returns to step S2013.

When determining that the SPIN button 46 has been operated (YES), the main CPU 71 conducts a lottery for a dividend of the roulette game (step S2017). This processing determines one of the targets 201A to 201H with reference to the roulette game dividend table shown in FIG. 12.

Next, the main CPU 71 conducts roulette effect display processing (step S2019). This processing displays the images of targets 201A to 201H indicating dividends and shows them brightly one by one in the clockwise direction. That is to say, the processing shows the image of a roulette game in such a manner that the targets 201A to 201H are sequentially and clockwise illuminated with a light. Subsequently, the processing gradually slows down the clockwise movement and eventually stops the movement to light up the single target determined by lottery among the targets 201A to 201H.

Next, the main CPU 71 performs payout processing (step S2021) and exits this subroutine. This processing pays out a dividend corresponding to the value obtained by multiplying the number of credits of the dividend associated with one of the target 201A to 201H determined by a dividend lottery in the roulette game in step S2017 by the total number of free games provided in the bonus game processing (see step S1727) and the number of bets designated in step S44 (the 1-BET button 34, the 2-BET button 35, the 3-BET button 37, the 4-BET button 38, the 5-BET button 39, or the MAX-BET button 45) to provide it to the player. The dividend is stored in the number-of-payouts storage area provided in the RAM 73.

For example, assuming that the target 201H is determined by a dividend lottery in the roulette game in step S2017, 120 free games in total are provided in the bonus game processing, and 3 bets are designated in step S44, the dividend is calculated by 50 credits of the dividend associated with the target 201H×120 games×3 bets=1800; accordingly, 1800 credits are paid out to be provided to the player.

Furthermore, the processing in step S2021 displays the number of credits of the dividend calculated in step S2021 on the lower image display panel 141.

It is to be noted that the processing in step S2021 may define the expectation values for the dividends to be provided in the case of choice of a roulette game to be equal to the values obtained by multiplying the expectation values for awards to be provided per free game by the number of provided free games.

What is claimed is:

1. A gaming machine for determining a game result in accordance with symbols rearranged out of a plurality of kinds of symbols, the gaming machine comprising:
a memory for storing symbol arrays formed of a plurality of symbols, the symbol arrays being associated with a plurality of scroll lines on a one-to-one basis;
a display having a display region in which symbols are rearranged; and
a controller for controlling a unit game in which the symbol arrays associated with the plurality of scroll lines are scrolled at a predetermined speed and then symbols are rearranged in the display region to determine a game result, the controller being programmed to perform the following processing of (1-1) to (1-4):
(1-1) determining symbols to be rearranged in the display region at random;
(1-2) selecting one kind of symbols from the plurality kinds of symbols at random;
(1-3) successively placing the one kind of symbols in at least one of the symbol arrays associated with the plurality of scroll lines and storing the symbol arrays in the memory; and
(1-4) scrolling the symbol arrays associated with the plurality of scroll lines based on the symbol arrays stored in the memory in the processing of (1-3).

2. The gaming machine according to claim 1, wherein the processing of (1-4) includes the following processing of (2-1):
(2-1) in a case where the processing of (1-3) successively places the one kind of symbols, scrolling the at least one of the symbol arrays including the one kind of symbols at a speed different from the predetermined speed.

3. The gaming machine according to claim 1, wherein the processing of (1-2) includes the following processing of (3-1):
(3-1) selecting one kind of symbols from the plurality of kinds of symbols before starting scrolling the symbol arrays.

4. The gaming machine according to claim 1,
wherein the unit game is performed in both of a base game mode and a bonus game mode entered from the base game mode, and
wherein the processing of (1-2) to (1-4) is performed in at least either the base game mode or the bonus game mode.

5. The gaming machine according to claim 1, wherein the processing of (1-3) includes the following processing of (5-1):
(5-1) successively placing the one kind of symbols along a scroll line in a direction away from symbols rearranged in the display region in a previous unit game, from a position away from the symbols by a predetermined number of symbols.

6. The gaming machine according to claim 1, further comprising:
an operation button for detecting an operation of a player and outputting a start signal to start scrolling of the plurality of scroll lines,
wherein the processing of (1-2) includes the following processing of (6-1):
(6-1) selecting one kind of symbols from the plurality kinds of symbols by lottery in response to detection of the start signal, and
wherein the processing of (1-3) includes the following processing of (6-2):
(6-2) rewriting the symbol arrays in such a manner that the one kind of symbols selected by the processing of (6-1) are successively placed along at least one of the plurality of scroll lines and storing the symbol arrays in the memory.

7. The gaming machine according to claim 2, wherein the processing of (2-1) includes the following processing of (7-1) and (7-2):
(7-1) in a case where the one kind of symbols are not a predetermined kind of symbols, scrolling the at least one of the symbol arrays including the one kind of symbols at the predetermined speed; and
(7-2) in a case where the one kind of symbols are the predetermined kind of symbols, scrolling the at least one of the symbol arrays including the one kind of symbols at the speed different from the predetermined speed.

8. The gaming machine according to claim 1, wherein the processing of (1-3) includes the following processing of (8-1):
(8-1) determining a number of the one kind of symbols to be successively placed at random.

9. The gaming machine according to claim 7, wherein the processing of (7-2) includes the following processing of (9-1) and (9-2):
(9-1) scrolling the at least one of the symbol arrays including the one kind of symbols at a speed slower than the predetermined speed; and
(9-2) after performing the processing of (9-1), stopping the plurality of scroll lines in substantially the same time as in a case of scrolling at the predetermined speed.

10. The gaming machine according to claim 4,
wherein the bonus game mode includes a free game mode in which at least one unit game is conducted and a roulette game mode in which a dividend is determined by a single lottery, and
wherein the controller is programmed to perform the following processing of (10-1):
(10-1) in a case where a number of unit games in the free game mode is greater than a predetermined number, allowing a player to select either the free game mode or the roulette game mode.

11. A gaming machine comprising:
a display for displaying a result of a unit game by rearranging a plurality of symbols;
a controller for performing a unit game in a base game mode which requires a bet, a unit game in a free game mode which does not require a bet, and a roulette game which determines one of a plurality of dividends; and
a memory for storing symbol arrays formed of a plurality of symbols, the symbol arrays being associated with a plurality of scroll lines on a one-to-one basis,
the display having a display region in which symbols are rearranged, and
the controller controlling a unit game in which the symbol arrays associated with the plurality of scroll lines are scrolled at a predetermined speed and then symbols are rearranged in the display region to determine a game result, the controller being programmed to perform the following processing of (11-1) to (11-5):
(11-1) determining symbols to be rearranged in the display region at random;
(11-2) selecting one kind of symbols from the plurality kinds of symbols at random;
(11-3) selecting one kind of symbols from the plurality kinds of symbols at random before starting scrolling the symbol arrays;
(11-4) successively placing the one kind of symbols in at least one of the symbol arrays associated with the plurality of scroll lines and storing the symbol arrays in the memory, the successively placing successively placing the one kind of symbols along a scroll line in a direction away from the symbols from a position away from a symbol rearranged in the display region in a previous unit game by a predetermined number of symbols; and
(11-5) in a case where the processing of (11-4) successively places the one kind of symbols, scrolling the symbol array including the one kind of symbols at a speed different from the predetermined speed.
